(19) United States
(12) Patent Application Publication
(10) Pub. No.: US 2015/0046842 A1
(43) Pub. Date: Feb. 12, 2015

(54) SYSTEM FOR PROVIDING A SOCIAL MEDIA COMPILATION

(71) Applicant: Diageo North America, Inc., Norwalk, CT (US)

(72) Inventors: Samuel Barr, Brooklyn, NY (US); Ivonne Azurdia, New York, NY (US); Stephanie Prevost, New York, NY (US); Wanjiru Mwangi, Brooklyn, NY (US); Andrew Bouchie, Brooklyn, NY (US); Oscar Martinez, White Plains, NY (US); Damian Classens, South Orange, NJ (US); Ignacio Navarro, Madrid (ES); Aaron P. Reitkopf, New York, NY (US)

(73) Assignee: Diageo North America, Inc., Norwalk, CT (US)

(21) Appl. No.: 14/142,147

(22) Filed: Dec. 27, 2013

Related U.S. Application Data
(60) Provisional application No. 61/863,876, filed on Aug. 8, 2013.

(51) Int. Cl. H04L 29/06

(52) U.S. Cl. CPC H04L 65/403
USPC 715/753

(57) ABSTRACT

A system for providing a social media compilation includes a computer processor and a memory device. The memory device stores at least one piece of computer code executable by the computers processor and data used by the computer code. The computer code includes an input module, a content aggregation module, and a compilation generation module. The input module receives compilation configuration information inputted by a first account holder. The compilation configuration information includes information identifying social media accounts of the first account holder. The content aggregation module aggregates items of social media content of the social media accounts of the first account holder based on the compilation configuration information. The compilation generation module generates a social media compilation based on the compilation configuration information and the items of social media content.

### CROSS-REFERENCE TO RELATED APPLICATION

This application claims the benefit of U.S. Provisional Application No. 61/863,876, filed on Aug. 8, 2013, the entire contents of which are incorporated herein by reference.

### BACKGROUND

1. Field of the Invention

The present application relates to a system for providing a social media compilation. More particularly, example aspects herein relate to systems, methods, and computer program products for providing a social media compilation based on items of social media content aggregated from one or more social media accounts of one or more social media account holders.

2. Description of Related Art

Social media platforms are changing the way people memorialize and reminisce about their experiences. Presently, social media account holders use numerous social media platforms to memorialize their experiences in various forms of social media content, such as photographs, status updates, tweets, check-ins, and the like. For example, a special occasion, such as a pleasure trip, a night out, or the like, may be memorialized in various forms of social media content in various social media accounts held by those who were present during the special occasion. If desired, those who were present during the special occasion may access their respective social media accounts of social media platforms to reminisce about the memorialized occasion. However, in order to view the items of social media content across the various social media accounts and/or platforms, each of the social media accounts/platforms typically is accessed separately.

Given the growing use of numerous social media accounts and/or platforms in memorializing and reminiscing about memorable experiences, it would be beneficial to have a convenient, centralized means of providing a custom video and/or audio compilation of social media content that is aggregated from numerous social media accounts and/or platforms, and to enable the compilation to be easily shared and enjoyed by many users.

### SUMMARY

The example embodiments herein provide systems, methods, and computer program products for providing a social media compilation. In accordance with one example aspect herein, a system includes a computer processor and a memory device. The memory device stores at least one piece of computer code executable by the computer processor as well as data used by the computer code. The computer code includes an input module, a content aggregation module, and a compilation generation module. The input module receives compilation configuration information, including information identifying social media accounts of the first account holder, inputted by a first account holder. Items of social media content of the social media accounts of the first account holder are aggregated by the content aggregation module based on the compilation configuration information. A social media compilation is generated by the compilation generation module based on the compilation configuration information and the items of social media content.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings.

FIG. 1 shows an example arrangement of various components of a system for providing a social media compilation, according to various example embodiments herein.

FIG. 2 is a block diagram of a computer for use with various example embodiments herein.

FIG. 3 illustrates examples of functional modules that may be included in a memory device and used for providing a social media compilation, according to various example embodiments herein.

FIG. 4 is a flowchart illustrating an example procedure for providing a social media compilation, according to various example embodiments herein.

FIG. 5 shows examples of interfaces, including interfaces for inputting user age information, in accordance with various example embodiments herein.

FIG. 6 shows examples of interfaces, including an interface for creating a user account, in accordance with various example embodiments herein.

FIG. 7 shows examples of interfaces, including interfaces for inputting user account information, in accordance with various example embodiments herein.

FIG. 8 shows examples of interfaces, including interfaces for inputting a comment regarding a social media compilation, in accordance with various example embodiments herein.

FIG. 9 shows examples of interfaces, including interfaces for inputting personal profile information, in accordance with various example embodiments herein.

FIG. 10 shows examples of interfaces, including interfaces for flagging a social media compilation, in accordance with various example embodiments herein.

FIG. 11 shows examples of interfaces, including interfaces for deleting a user account, in accordance with various example embodiments herein.

FIG. 12 shows examples of interfaces, including interfaces for sharing a social media compilation, in accordance with various example embodiments herein.

FIG. 13 shows examples of interfaces, including interfaces for retrieving a social media compilation by category, in accordance with various example embodiments herein.

FIG. 14 shows examples of interfaces, including interfaces for identifying social media compilations based on a list of friends, in accordance with various example embodiments herein.

FIG. 15 shows examples of interfaces, including interfaces for generating an invitation for a friend to create a user account, in accordance with various example embodiments herein.

FIG. 16 shows examples of interfaces, including interfaces for connecting an application to a social media account, in accordance with various example embodiments herein.

FIG. 17 shows examples of interfaces, including interfaces for selecting a date range for a social media compilation, in accordance with various example embodiments herein.

FIG. 18 shows examples of interfaces, including interfaces for adding, removing, and rearranging one or more items of social media content in a social media compilation, in accordance with various example embodiments herein.

FIG. 19 shows examples of interfaces, including interfaces for adding to a social media compilation one or more items of social media content from an album, in accordance with various example embodiments herein.

FIG. 20 shows examples of interfaces, including interfaces for removing one or more items of social media content from a social media compilation, in accordance with various example embodiments herein.

FIG. 21 shows examples of interfaces, including interfaces for determining the availability of any item(s) of social media content from a social media account of a friend, in accordance with various example embodiments herein.

FIG. 22 shows examples of interfaces, including interfaces for adding music to a social media compilation, in accordance with various example embodiments herein.

FIG. 23 shows examples of interfaces, including an interface for adding details to a social media compilation, in accordance with various example embodiments herein.

FIG. 24 shows examples of interfaces, including interfaces for editing a personal profile, in accordance with various example embodiments herein.

FIG. 25 shows examples of interfaces, including interfaces for changing a personal password, in accordance with various example embodiments herein.

FIG. 26 shows examples of interfaces, including interfaces for presenting one or more notices, in accordance with various example embodiments herein.

FIG. 27 shows examples of interfaces, including interfaces for logging out of an application, in accordance with various example embodiments herein.

FIG. 28 shows examples of interfaces, including interfaces for generating an email alert for resetting a personal password, in accordance with various example embodiments herein.

FIG. 29 shows examples of interfaces, including an interface for resetting a personal password, in accordance with various example embodiments herein.

### DETAILED DESCRIPTION

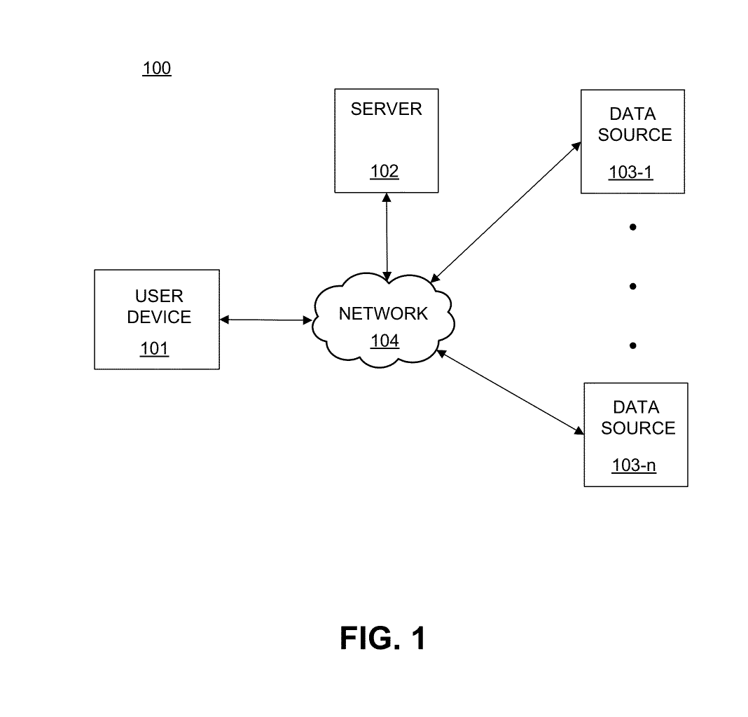

FIG. 1 shows an example arrangement of various components of a system 100 for providing a social media compilation, according to an example embodiment herein. The system includes a user device 101, a server 102, and a plurality of data sources 103-1 to 103-n (collectively 103) that are mutually coupled by way of a communication network 104 that enables data to be communicated therebetween. In some example embodiments, the communication network 104 may be a publicly accessible network, such as the Internet.

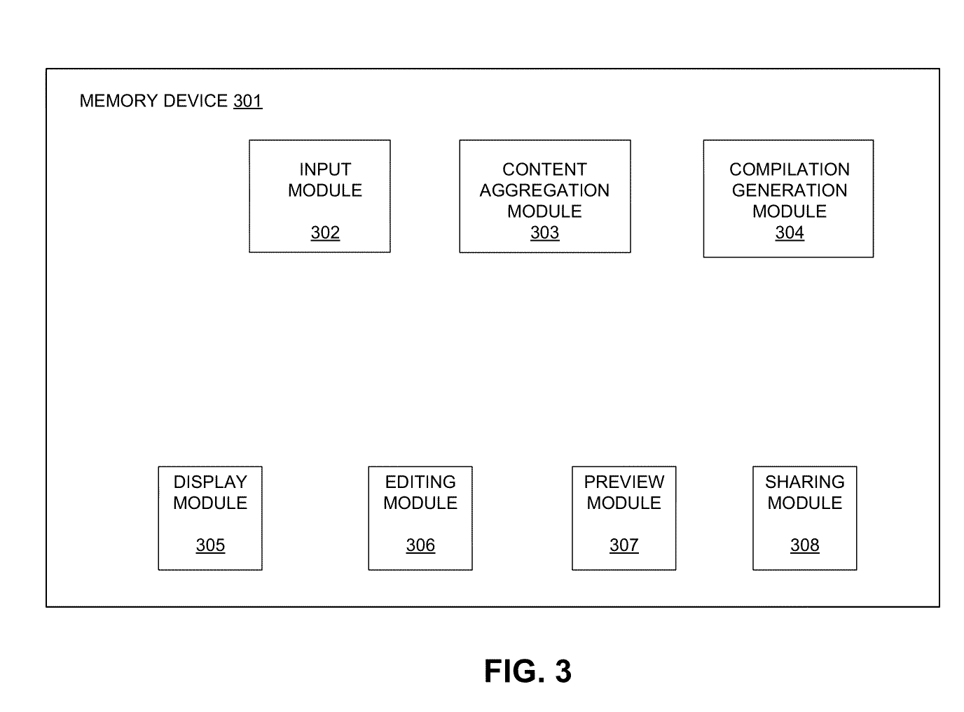

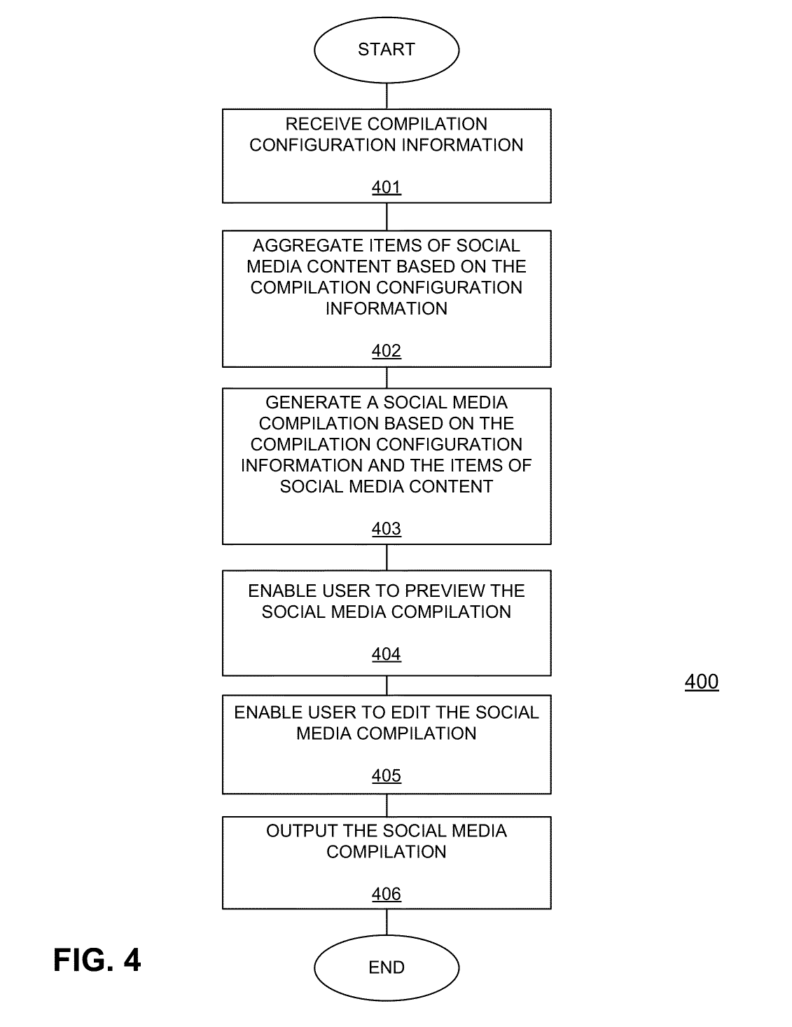

In general, and as will be described in more detail below in the context of FIGS. 3 and 4, the user device 101 executes software that enables a user (e.g., a holder of one or more social media accounts, sometimes referred to herein as a first account holder) to provide compilation configuration information to the server 102, and to cause the server 102 to (1) aggregate items of social media content from the plurality of data sources 103 based on the provided compilation configuration information and (2) generate a social media compilation based on the provided compilation configuration information and the aggregated items of social media content.

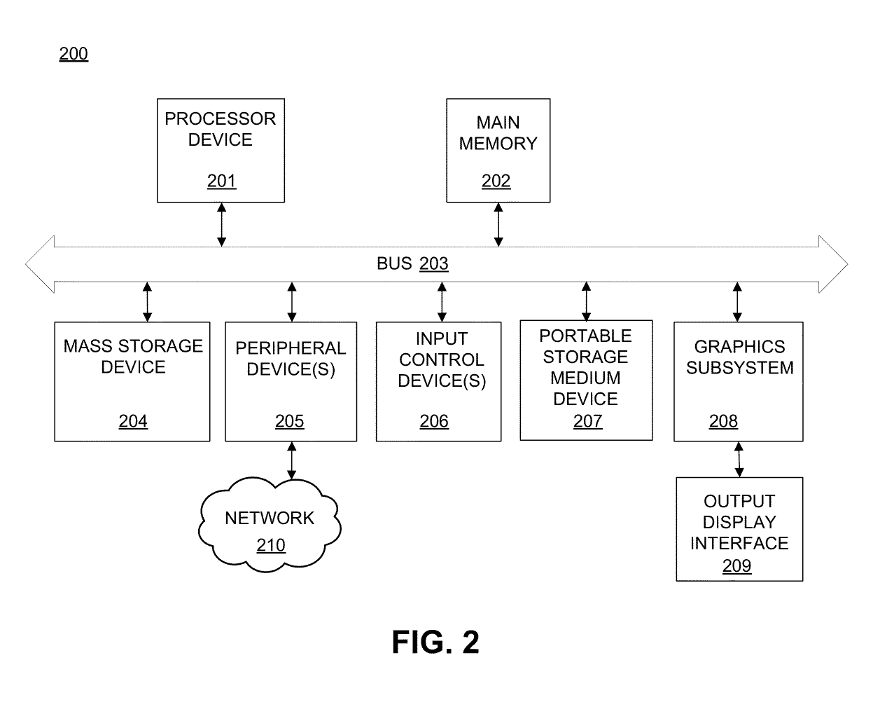

The user device 101 may be a general and/or special purpose computer (e.g., the computer system 200 described below in connection with FIG. 2), a mobile communication device, a laptop computer, a tablet computer, and/or any other user device suitable for a user to input information used to create and/or edit a social media compilation, and for providing a social media compilation created by the user or by another user, in accordance with the example embodiments herein. The server 102 may be a general and/or special purpose computer (e.g., computer system 200 described below). The software executed by the user device 101 may be Web-based software (e.g., software hosted by the server 102), for easy access by any user, local software hosted by the user device 101, and/or a combination of Web-based software and local software.

Each of the plurality data sources 103 is a source of data (e.g., items of social media content) stored by one or more social media service providers in connection with one or more social media accounts and/or platforms. For example, each of the data sources 103 may be a social media platform, such as a social media website, a social media application hosted by a social media service provider (e.g., Facebook®, Twitter®, Instagram®, Foursquare®, etc.), and/or a database provided by a social media service provider.

Having described a system 100 for providing a social media compilation, according to an example embodiment herein, reference will now be made to FIG. 2, which shows a block diagram of a general and/or special purpose computer system 200 that may be employed in accordance with some of the example embodiments herein. The computer system 200 may be, for example, a user device, a user computer, a client computer and/or a server computer, among other things. In some example embodiments herein, the computer system 200 may further represent the user device 101, the server 102, and/or one or more of the plurality of data sources 103-1 to 103-n described above in connection with FIG. 1.

The computer system 200 may include, without limitation, a computer processor 201, a main memory 202, and an interconnect bus 203. The computer processor 201 may include without limitation a single microprocessor, or may include a plurality of microprocessors for configuring the computer system 200 as a multi-processor system. The main memory 202 stores, among other things, instructions and/or data for execution by the processor device 201. The main memory 202 may include banks of dynamic random access memory (DRAM), as well as cache memory.

The computer system 200 may further include mass storage device(s) 204, peripheral device(s) 205, input control device(s) 206, portable storage medium device(s) 207, graphics subsystem(s) 208, and/or one or more output display(s) 209. For explanatory purposes, all components in the computer system 200 are shown in FIG. 2 as being coupled via the bus 203. However, the computer system 200 is not so limited. Devices of the computer system 200 may be coupled via one or more data-transport devices known in the art. For example, the computer processor 201 and/or the main memory 202 may be coupled via a local microprocessor bus. The mass storage device(s) 204, the peripheral device(s) 205, the portable storage medium device(s) 207, and/or the graphics subsystem(s) 208 may be coupled via one or more input/output (I/O) buses. The mass storage device(s) 204 may be nonvolatile storage device(s) for storing data and/or instructions for use by the computer processor 201. The mass storage device(s) 204 may be implemented, for example, with one or more magnetic disk drive(s), solid state disk drive(s), and/or optical disk drive(s). In a software-related embodiment, at least one mass storage device 204 is configured for loading contents of the mass storage device 204 into the main memory 202.

Each portable storage medium device 207 operates in conjunction with a nonvolatile portable storage medium, such as, for example, a compact disc with a read-only memory (CD-ROM) or a non-volatile storage chip (Flash), to input and output data and code to and from the computer system 200. In some embodiments, the software for storing an internal identifier in metadata may be stored on a portable storage medium, and may be inputted into the computer system 200 via the portable storage medium device 207. The peripheral device(s) 205 may include any type of computer support device, such as, for example, an input/output (I/O) interface configured to add additional functionality to the computer system 200. For example, the peripheral device(s) 205 may include a network interface card for interfacing the computer system 200 with a network 210.

The input control device(s) 206 provide among other things, a portion of the user interface for a user of the computer system 200. The input control device(s) 206 may include a keypad, a cursor control device, a touch sensitive surface coupled with the output display(s) 209 or standalone, a camera, a microphone, infrared sensors, knobs, buttons, and the like. The keypad may be configured for inputting alphanumeric characters and/or other key information. The cursor control device may include, for example, a mouse, a trackball, a stylus, and/or cursor direction keys. In order to display textual and graphical information, the computer system 200 may utilize the graphics subsystem(s) 208 and the output display(s) 209. The output display(s) 209 may include a cathode ray tube (CRT) display, a liquid crystal display (LCD), a projector device, and the like. Each graphics subsystem 208 receives textual and graphical information, and processes the information for output to at least one of the output display(s) 209.

Each component of the computer system 200 may represent a broad category of a computer component of a general and/or special purpose computer. Components of the computer system 200 are not limited to the specific implementations provided here.

Portions of the example embodiments of the invention may be conveniently implemented by using a conventional general purpose computer, a specialized digital computer, and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein, which can be used to control, or cause, a computer to perform any of the procedures of the example embodiments of the invention. The storage medium may include without limitation a floppy disk, a mini disk, an optical disc, a Blu-ray Disc™, a DVD, a CD-ROM, a micro drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include, without limitation, device drivers, operating systems, and user applications. Additionally, such computer readable media further includes software for performing example aspects of the invention, as described herein.

Included in the programming and/or software of the general and/or special purpose computer or microprocessor are software modules for implementing the procedures described herein.

Having described a general and/or special purpose computer 200 that may be employed in accordance with some of the example embodiments herein, reference will now be made to FIG. 3, which illustrates example functional modules that may be included in a memory device 301, in accordance with example embodiments herein. In some example embodiments, the memory device 301 is included in the computer system 200 described above in the context of FIG. 2, further represents the main memory 202 in part or in whole, and is used for providing a social media compilation. For example, although not shown in FIG. 3 for purposes of convenience, the memory device 301 is coupled to a computer processor (e.g., the computer processor 201) that, in turn, is coupled to one or more displays (e.g., the output display(s) 209) and optionally to one or more capabilities to exchange data over a network (e.g., the network 210). In one example embodiment, each display device 209 is structured to display a graphical interface (e.g., a GUI) to a user based on computer code (e.g., modules 302 through 308) executed by the computer processor 201. An input device (e.g., the input control device 206) is structured to receive information from the user via the user device 101. In some example embodiments herein, one or more of the modules 302 through 308 may be used to implement one or more of the functions associated with one or more of blocks 401 through 406, which are described in further detail below in the context of FIG. 4.

As shown in FIG. 3, the modules stored within the memory device 301 include an input module 302, a content aggregation module 303, a compilation generation module 304, a display module 305, an editing module 306, a preview module 307, and a sharing module 308. As will be described in further detail below, each of the modules 302 through 308 includes computer-executable code that imparts functionality to the computer system 200 when executed by the computer processor 201 as well as data related to that code. Additionally, the memory device 301 stores computer programs and data for applications that a user may interact with via one or more input devices 206.

In one example embodiment herein, the input module 302 receives compilation configuration information inputted by an account holder (i.e., a holder of one or more social media accounts, sometimes referred to herein as a first account holder). The compilation configuration information, in one example, may include information identifying one or more social media accounts of the first account holder.

The content aggregation module 303 aggregates items of social media content from the one or more social media accounts of the first account holder based on the compilation configuration information received by the input module 302. The content aggregation module 303 aggregates the items of social media content by using one or more application programming interfaces of one or more social media service providers, in one example.

In some example embodiments, the compilation configuration information inputted by the first account holder includes sequence information for ordering the items of social media content, and the content aggregation module 303 aggregates the items of social media content in a desired sequence according to the sequence information.

In another example embodiment herein, the compilation configuration information may include a temporal range for the items of social media content to be aggregated by the content aggregation module 303 for the social media compilation.

In another example aspect herein, the compilation configuration information includes information identifying one or more social media accounts of one or more additional account holders (e.g., sometimes referred to herein as a second account holder), and the content aggregation module 303 aggregates items of social media content of the one or more social media accounts of the one or more additional account holders in addition to aggregating the items of social media content of the first account holder.

The compilation generation module 304 generates a social media compilation based on the compilation configuration information received by the input module 302 and the items of social media content aggregated by the content aggregation module 303.

In one example embodiment, the items of social media content used by the compilation generation module 304 are not stored in a memory device or in another storage medium associated with the social media compilation.

In another example aspect herein, the compilation configuration information received by the input module 302 includes audio information of a soundtrack to be associated with the social media compilation, and the compilation generation module 304 outputs the social media compilation in conjunction with the soundtrack.

In accordance with another example embodiment herein, the compilation generation module 304 generates the social media compilation by: (1) adding the textual social media entries as overlays to one or more of the photographic social media entries, or one or more of the graphical social media entries, or both, to produce merged entries, and (2) arranging the merged entries in a sequence that includes one or more other photographic social media entries, or one or more other graphical social media entries, or both; and the compilation generation module 304 outputs the sequence concurrently with an audio soundtrack. In yet a further example embodiment, the compilation generation module 304 arranges the items of social media content in chronological order.

According to another example herein, the social media compilation is not stored on a computer-readable storage medium and, instead, each time a hyperlink associated with the social media compilation is selected, the content aggregation module 303 aggregates anew the items of social media content according to the compilation configuration information, and the compilation generation module 304 generates anew the social media compilation.

According to one example, the display module 305 produces an array of data, the array including a first dimension with entries corresponding to one or more account holders and a second dimension with entries corresponding to one or more social media accounts of the one or more account holders. Each entry of the array is selectable by the first account holder via the input module 302 to cause items of social media content of the one or more social media accounts of the one or more account holders to be aggregated by the content aggregation module 303 for the social media compilation or to be excluded from the social media compilation.

In some example aspects herein, the editing module 306 enables the first account holder to perform any one or a combination of: (1) editing the social media compilation generated by the compilation generation module 304; (2) arranging the items of social media content in the social media compilation to be in a customized order sequence; (3) selecting one or more of the items of social media content to be included in the social media compilation or to be excluded from the social media compilation; (4) selecting, from a plurality of predefined audio soundtracks, an audio soundtrack to be output together with the social media compilation; and/or (5) uploading an audio soundtrack to be output together with the social media compilation.

The preview module 307 enables the first account holder to preview the social media compilation, to determine whether any edits to the social media compilation should be made, for example, before the social media compilation is shared.

The sharing module 308 outputs the social media compilation to a display device when the social media compilation is requested via a hyperlink. The sharing module 308 also may enable the first account holder to provide a link to one or more other users (e.g., one or more additional social media account holders) by which the social media compilation may be accessed. The link may, in one example, be a shortened uniform resource locator (URL).

### First Example Embodiment

Reference will now be made to FIG. 4, which shows a flowchart illustrating an example procedure 400 for providing a social media compilation, in accordance with a first example embodiment herein. At block 401, compilation configuration information, which is inputted by a holder of one or more social media accounts (e.g., a first account holder) via a user device (e.g., the user device 101 (FIG. 1)), is received.

In this example embodiment, the compilation configuration information is received (block 401) as data entered by the first account holder via a GUI. The GUI may be: (1) a Web-based GUI (e.g., a GUI provided as a webpage and/or a Web-based application hosted by the server 102 and accessed via the user device 101 (FIG. 1)) and/or (2) a local GUI (e.g., a GUI provided as an application hosted by the user device 101 (FIG. 1)). The GUI may include a plurality of GUI elements (including, for example, a window, a menu, an icon, a control, a widget, a text box, a button, a drop-down list, a list box, a check box, a radio button, a tab, etc.) by which the first account holder may enter data representing the compilation configuration information.

As described in further detail below, the compilation configuration information received at block 401 may include various types of information relating to the configuration of a social media compilation.

In this example embodiment, the compilation configuration information includes information identifying the one or more social media accounts of the first account holder. The social media accounts may include any one or a combination of: (1) a Facebook® account, (2) a Twitter® account, (3) an Instagram® account, and/or (4) a Foursquare® account. The information identifying the social media accounts of the first account holder may also include credentials usable to log into the social media accounts of the first account holder.

The compilation configuration information further may include a temporal range for the items of social media content to be aggregated (at block 402, described below) for the social media compilation.

In yet another example aspect, the compilation configuration information further includes any one or a combination of: (1) a compilation identifier, which identifies a name associated with the social media compilation; (2) a location identifier, which identifies a geographical location associated with the social media compilation; (3) a date identifier, which identifies a date associated with the social media compilation; (4) an event identifier, which identifies an event associated with the social media compilation; and (5) a category identifier, which identifies a category, from a plurality of predefined categories, to which the social media compilation belongs.

In another example aspect, the compilation configuration information includes geographical information, such as an indication of a geographical area (e.g., a state, a territory, a county, or a custom defined geographical region) for the items of social media content to be aggregated (at block 402, described below) for the social media compilation. The geographical information may be inputted by interacting with a GUI element (e.g., a drop down box, a map, and/or the like) to select a geographical area such as a state, territory, and/or the like. In another example, the geographical information may be inputted by dragging a border around a map to define a custom geographical region.

According to some example aspects herein, the procedure 400 further includes a step (not shown) of storing at least one of: (1) the information identifying the social media accounts of the first account holder, (2) credentials usable to log into the social media accounts of the first account holder, (3) information identifying the social media accounts of at least one account holder other than the first account holder, and/or (4) the compilation configuration information.

At block 402, items of social media content of the one or more social media accounts of the first account holder are aggregated based on the compilation configuration information. In one example, the compilation configuration information inputted by the first account holder at block 401 includes sequence information for ordering the items of social media content, and the items of social media content are aggregated at block 402 in a desired sequence according to the sequence information.

In another example aspect herein, the compilation configuration information received at block 401 further includes information identifying a social media account of one or more additional account holders, such as, for example, one or more friends of the first account holder. In this case, at block 402, in addition to aggregating the items of social media content from one or more social media accounts of the first account holder, items of social media content from one or more social media accounts of the one or more additional account holders also are aggregated.

In accordance with another example aspect herein, the items of social media content are aggregated by using one or more application programming interfaces of one or more social media service providers.

In another example, where the compilation configuration information includes geographical information (as described above in connection with block 401), the items of social media content are aggregated based, at least in part, on the geographical information, which may be stored as metadata associated with one or more items of social media content. In one example, the geographical information (e.g., metadata) for an item of social media content may be generated by a user device that was used to create the item of social media content based on location information obtained by the user device from GPS satellites and/or cellular towers. For example, the user device may record the geographical information at or around the same time that the item of social media content was created (e.g., when a photo was taken). In one example, the geographical information may indicate where a user device was located at the time the item of social media content was created. In this manner, a social media compilation may be generated (as described below in connection with block 403) by including only items of social media content from a particular designated geographical region.

At block 403, a social media compilation is generated based on the compilation configuration information received at block 401 and the items of social media content aggregated at block 402. In one example embodiment, the items of social media content used at block 402 to generate the social media compilation are not stored in a memory device associated with the social media compilation. In this case, each time a hyperlink associated with the social media compilation is selected, the items of social media content are aggregated anew according to the compilation configuration information, and the social media compilation is generated anew.

According to some example aspects, the items of social media content aggregated at block 402 include any one or a combination of: (1) photographic social media entries, (2) graphical social media entries, (3) videographic social media entries, and/or (4) textual social media entries. The social media compilation is generated, at least in part, by (1) adding the textual social media entries as overlays to one or more of the photographic social media entries, or one or more of the graphical social media entries, or both, to produce merged entries, and (2) arranging the merged entries in a sequence that includes one or more other photographic social media entries, or one or more other graphical social media entries, or both.

According to another example herein, the generating of the social media compilation at block 403 may also include arranging the items of social media content in chronological order. In another example, the generating of the social media compilation at block 403 includes arranging the items of social media content in the social media compilation to be in a customized order sequence.

The procedure 400 also may include one or both of optional blocks 404 and 405. At block 404, the social media compilation generated at block 403 is previewed to enable the first account holder to determine whether any edits should be made to the social media compilation, for example, before the social media compilation is shared.

At block 405, the first account holder edits the social media compilation generated at block 403. In one example, an array of data is produced and provided to the first account holder by way of a GUI. The array includes a first dimension with entries corresponding to one or more account holders and a second dimension with entries corresponding to one or more social media accounts of the one or more account holders. Each entry of the array is selectable by the first account holder to cause items of social media content of the one or more social media accounts of the one or more account holders to be aggregated for the social media compilation or to be excluded from the social media compilation.

According to another example aspect herein, the editing of the social media compilation at block 405 includes any one or a combination of: (1) receiving a selection of one or more of the items of social media content to be included in the social media compilation or to be excluded from the social media compilation; (2) receiving a selection of one of a plurality of predefined audio soundtracks audio soundtracks to be output together with the social media compilation; and/or (3) uploading an audio soundtrack to be output together with the social media compilation.

At block 406, the social media compilation generated at block 403 is outputted, for example, via a display device and/or an audio device. In another example embodiment, the compilation configuration information received at block 401 also includes audio information of a soundtrack to be associated with the social media compilation, and the outputting of the social media compilation at block 406 includes outputting the social media compilation in conjunction with the soundtrack.

The outputting of the social media compilation at block 406 includes outputting the social media compilation to a display device when the social media compilation is requested via a hyperlink.

In accordance with one example aspect herein, the social media compilation generated at block 403 is not stored on a computer-readable storage medium and, each time a hyperlink associated with the social media compilation is selected, (1) the items of social media content are aggregating anew (block 402) according to the compilation configuration information and (2) the social media compilation is generating anew (block 403).

In accordance with another example aspect herein, images are retrieved, for example, using an authenticated retrieval procedure/protocol, from a predetermined set of social media feeds (e.g., Facebook®, Twitter®, Instagram®, Foursquare®, and/or another social media service provider or Digital Rights Management (DRM)-authorized source) that index the images using a combination of location information, date information, and/or time information.

Text for annotating the images is retrieved, for example, using an authenticated retrieval procedure/protocol, from a source of comments (e.g., Facebook®, Twitter®, Instagram®, Foursquare®, and/or another social media service provider or DRM-authorized source).

A social media compilation is configured by: (1) selecting and ordering the images into a narrative, (2) selecting text excerpts to be overlaid onto the narrative, (3) adding a title, location, and credited producers, and (4) using an interface to a DRM-authorized music source to select a song to be played with the social media compilation.

A client device, which may be an iOS-based device, an Android-based device, or a device hosting another web browser, initiates a procedure for viewing the social media compilation by: (1) downloading the social media compilation configuration information via a communication interface (e.g., a representational state transfer (REST) interface) to a web service; (2) storing the social media compilation configuration information in a database (e.g., a Postgres database); and (3) queuing a request to view the social media compilation (e.g., in an Amazon Simple Queue Service queue).

According to one example, the social media compilation is created by using a video creation program (VCP) written in ActionScript 2.0. A unique sequence of combination effects (e.g., view and hold, transitions, transitions with rotations, transition with zoom in/out, etc.) is generated for the social media compilation. A different random overlay of text is generated for the social media compilation. A title screen, credits, and/or a brand image are added to the social media compilation, for example at an end portion of the compilation. In one example, the output of the VCP is a flash file having a .SWF file format. The .SWF file may be transferred to a Ubuntu operating environment. A utility (e.g., a gnash Unix utility) is used to create a raw video file from the SWF file. A utility (e.g., a mencoder Unix utility) is used to create a .mp4 file including an integrated .mp3 soundtrack selected during configuration of the social media compilation.

According to another example, the social media compilation is shared by (1) communicating the social media compilation (e.g., as an encoded video) to a cloud storage service provider (e.g., Amazon Simple Storage Service) for further distribution to additional viewers. A notification is transmitted to a web service indicating that the encoded video is ready to be made available and, the video is then made available to polling clients and for search as needed. In one example aspect, for performance optimization a mobile application can poll a web service (e.g., Amazon Cloudfront service) that facilitates low-latency distribution of content via the Internet of another communication network, for example by using caching techniques. The video may also be uploaded from a cloud storage service provider to a content distribution network (CDN) (e.g., from Amazon Simple Storage Service to a Brightcove video transcoding and delivery service) to enable the video/social media compilation to be viewed via multiple web browsers.

In accordance with another example aspect herein, a social media compilation may be configured and/or created based on geographical location.

### Second Example Embodiment

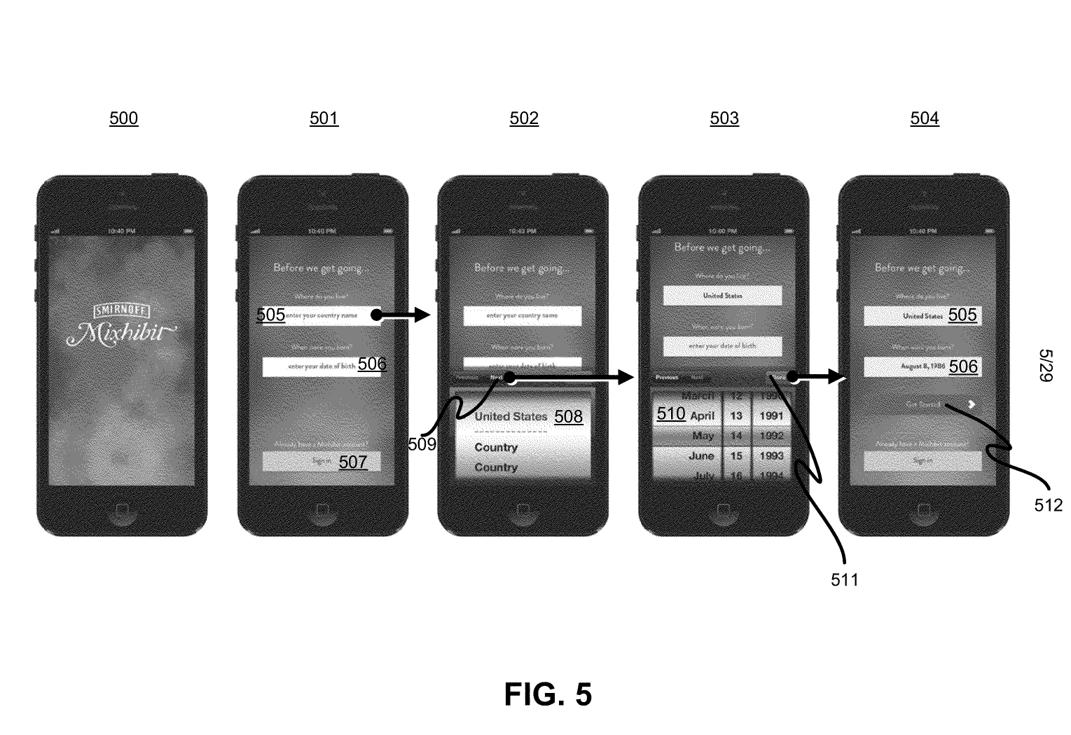

Having described an example of a procedure for providing a social media compilation, reference will now be made to FIGS. 5 through 29, which show various interfaces of a software application for providing a social media compilation, in accordance with a second example embodiment herein. Although certain elements (e.g., buttons, menus, icons, and/or the like) may appear in multiple places in FIGS. 5 through 29, different reference numbers may be used for such elements in each place, for purposes of convenience. Additionally, in certain ones of FIGS. 5 through 29, arrows are included to indicate examples of causality between an element (e.g., a button) of an interface being selected and another interface being subsequently presented as a result.

The application, in one example, is hosted by a user device, such as the user device 101 of FIG. 1 and/or the computer system 200 of FIG. 2, and employs one or more of the functional modules 302 through 308 of FIG. 3 to implement one or more of the functions associated with blocks 401 through 406, respectively, of FIG. 4.

In a case where the user device is a mobile communication device, the application may be, for example, a mobile application (or app) such as a mobile application compatible with an Apple iOS® operating system, an Android® operating system, or another type of operating system. In a case where the user device is a general and/or special purpose computer system (e.g., a desktop or laptop computer system), the application may be compatible with a Microsoft Windows® operating system, an Apple OS X® operating system, or any other type of operating system. The application may be a Web-based application, a local application, or a combination of a Web-based and local application.

### Application Launch/Age Gate

FIG. 5 shows example interfaces 500 through 504 that may be provided via the application, in accordance with the second example embodiment herein. In particular, the interface 500 illustrates an example launch image that can be presented to a user upon launching the application.

After the launch image is presented, the interface 501 may be presented, to enable the user to input information (e.g., country information, user age information, and/or the like) that is used to determine whether the user should be granted access to the application and/or the social media compilations presented therein. The interface 501 includes input fields 505, 506, and 507 that the user may select to (1) input a country where the user lives, (2) input the user's date of birth, and (3) sign into the application, respectively.

The user may select the country input field 505, thereby causing the interface 502 to be presented. The interface 502 includes an interface element 508 (e.g., a dropdown or scrollable list) from which the user may select the user's country. After the user has selected the user's country via the interface element 508, the user may select a button 509 (e.g., designated “Next”), thereby causing the interface 503 to be presented. The interface 503 includes an interface element 510 (e.g., a dropdown or scrollable list) from which the user may select the user's date of birth (e.g., month, day, and year). After the user has selected his or her date of birth, the user may select a button 511 (e.g., designated “Done”), thereby causing the interface 504 to be presented. As shown in the interface 504, the country and date of birth previously inputted by the user is shown in input fields 505 and 506. The user may select a button 512 (e.g., designated “Get Started”), thereby causing the application to determine, based on the previously inputted country and date of birth, whether to grant the user access to the application and/or the social media compilations therein.

In one example, after the user selects the button 512, the previously inputted country and date of birth are transmitted from the user device (e.g., the user device 101) to a server (e.g., the server 102), which performs a look-up in a memory to determine whether any predetermined age-related rule (e.g., a rule prohibiting access to alcohol-related content for persons under a predetermined age) is stored in the memory in connection with the particular country that the user has inputted. If the server determines that no predetermined age-related rule is stored in the memory in connection with the particular country that the user has inputted, then the user is granted access to the application. If, on the other hand, the server determines that a predetermined age-related rule is stored in the memory in connection with the particular country that the user has inputted, then the server compares the previously entered date of birth to an age threshold associated with the predetermined age-related rule. If the date of birth is equal to or greater than the age threshold, then the user is granted access to the application. If the date of birth is less than the age threshold, then the user is denied access to the application.

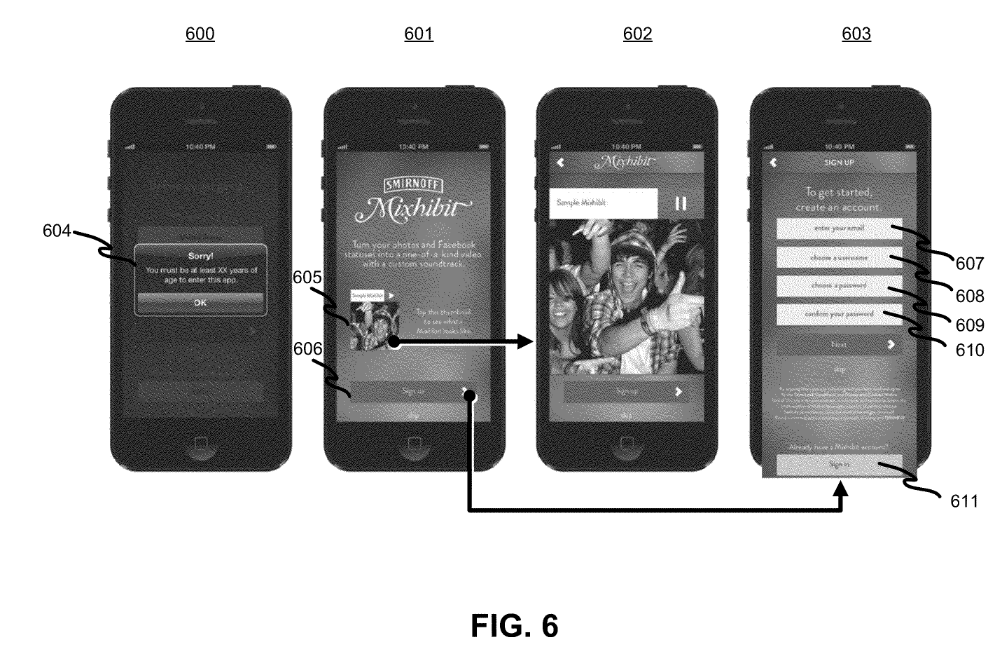

Reference will now be made to the interfaces 600 through 603 shown in FIG. 6. The interface 600 shows a dialog box 604 that may be presented to the user indicating that it has been determined (as described above in connection with FIG. 5) that the user does not meet the age threshold and is thus denied access to the application. The interface 601 is a welcome interface that may be presented to the user upon being granted access to the application (as described above in connection with FIG. 5). The interface 601 includes a thumbnail 605 and a sign up button 606. The user may select the thumbnail 605 to cause the interface 602 to be presented, enabling the user to view an example of a social media compilation. The user may select the sign up button 606 shown in the interface 602 to cause the interface 603 to be presented, enabling the user to sign up for a new user account for the application. The interface 603 includes input fields 607 through 610. The input fields 607 and 608 enable the user to input (1) an email address and (2) a username, respectively, to be associated with the new user account. The input fields 609 and 610 enable the user to input a new password for the new account. If the user already has configured a user account for the application, then the user may select the sign in button 611 to sign into the user account.

### Creating an Account for the Application

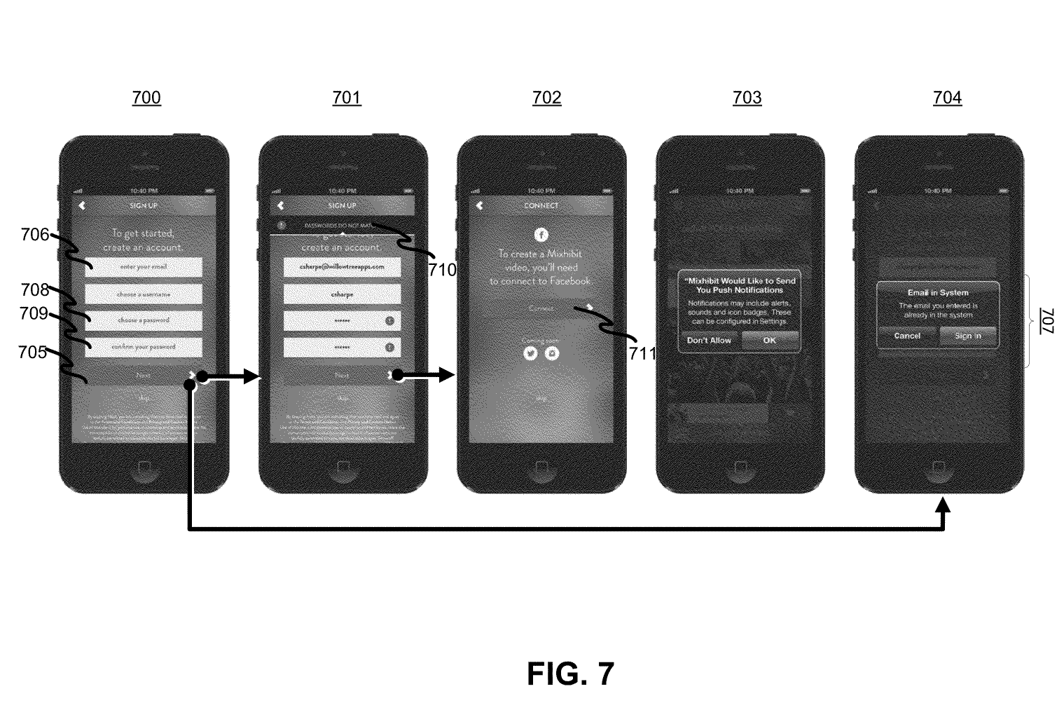

Reference will now be made to the interfaces 700 through 704 shown in FIG. 7. The interface 700 enables the user to sign up for a new user account (as described above in connection with FIG. 6). If the user selects the next button 705 after having entered into the input element 706 an email address that has previously been associated with a user account, then the interface 704 is presented, including a dialog box 707 indicating that the entered email address is already associated with a user account. If the user selects the next button 705 after having entered non-matching passwords in fields 708 and 709, then the interface 701 is presented, including a dialog box 710 indicating that the entered passwords do not match.

If the user selects the next button 705 after having input a proper email address, user name, and passwords in the corresponding fields of the interface 701, then the interface 702 is presented. The interface 702 includes a connect button 711 that, when selected, enables the user to connect to one or more social media accounts (e.g., Facebook®, Twitter®, Instagram®, Foursquare®, etc.) of which the user is the account holder. The user may select the connect button 711 to cause the interface 703 to be presented. The interface 703 includes a dialog box that enables the user to select whether to allow so-called “push” notifications (e.g., alerts, sounds, icon badges, and/or the like) to be sent by the application.

### Navigating the Application

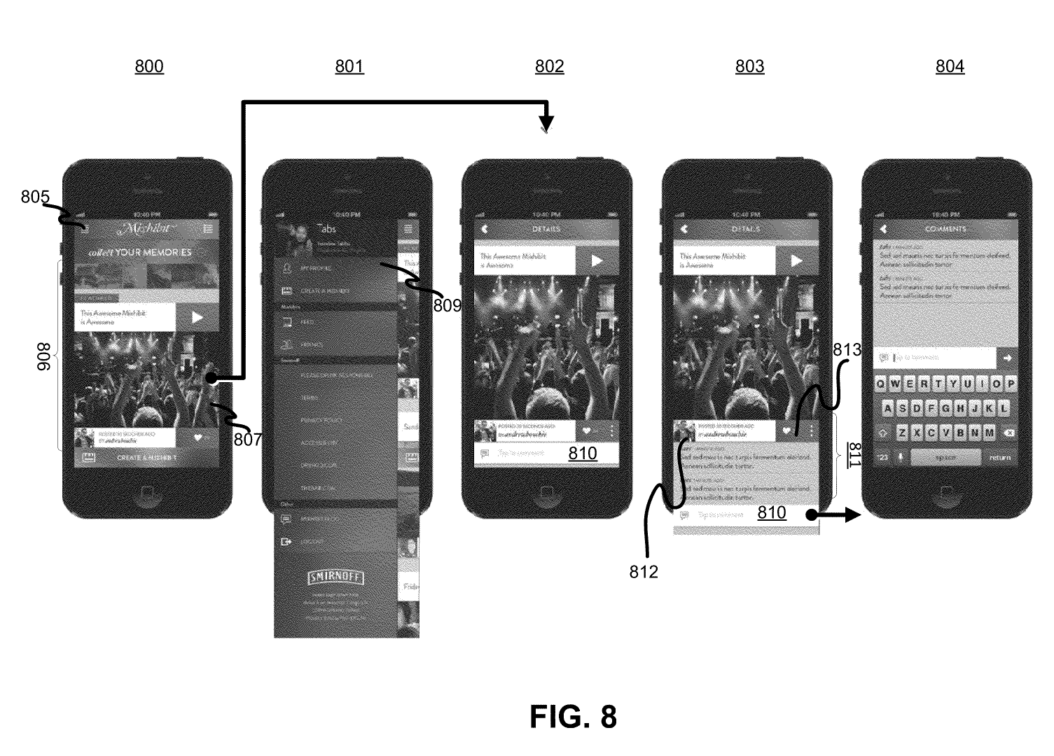

Reference will now be made to the interfaces 800 through 804 shown in FIG. 8. The interface 800, which may be presented to the user after the user has successfully logged into his or her user account, includes a menu button 805 and a social media compilation feed 806 that lists one or more graphical images 807 and/or messages 808 corresponding to one or more respective social media compilations. In one example, the social media compilation feed 806 includes a scrollable listing of social media compilations that with which the user is associated. Examples of social media compilations that the user may be associated with include (1) social media compilations that the user has created and (2) social media compilations that have been created by other account holders (e.g., friends of the user) whose user accounts are linked to the user account of the user. The listing of social media compilations may be organized by category, in a chronological order in which they were created, and/or according to any other suitable criteria.

If the user selects the menu button 805, then the interface 801 is presented, providing the user with a list 809 of menu items that the user may select, for example, to view the user's personal profile, create a social media compilation, view a social media compilation feed, view friend information, log out of the application, and/or the like.

### Commenting on a Social Media Compilation

If, in the interface 800, the user selects the graphical image 807 corresponding to a social media compilation, then the interface 802 is presented, providing additional details regarding the social media compilation, as well as a comment input field 810. If the user selects the comment input field 810, then the interface 804 is presented, enabling the user to input a comment in connection with the compilation. Example comments 811 inputted in connection with the compilation are shown in the interface 803. A portion 812 of the interface 803 includes additional information, such as an author of the corresponding social media compilation and/or an amount of time that has elapsed since the social media compilation has been created. An icon 813 indicates how many so-called “likes” have been received for the social media compilation. In one example, the user may select the icon 813 to “like” the social media compilation.

### Personal Profiles

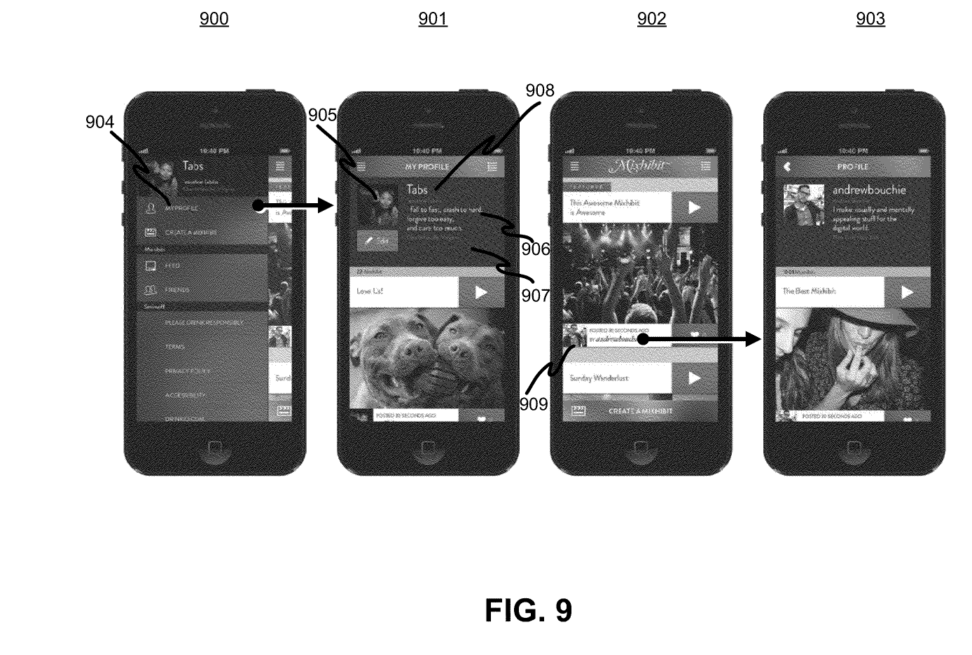

Reference will now be made to the interfaces 900 through 903 shown in FIG. 9. The user may select the menu item 904 for viewing and/or modifying the user's personal profile, to cause the interface 901 to be presented. The interface 901 includes items of a personal profile of the user, such as a user account photograph 905 selected and/or uploaded by the user, a profile caption 906 and/or geographical location 907 entered by the user, a name or identifier 908 of the user account, a listing of social media compilations created by the user, and/or the like. If the user selects an identifier 909 (e.g., a user name) that is associated with a second user (e.g., another user account holder), then the interface 903 is presented, showing a personal profile of that second user.

### Flagging a Social Media Compilation

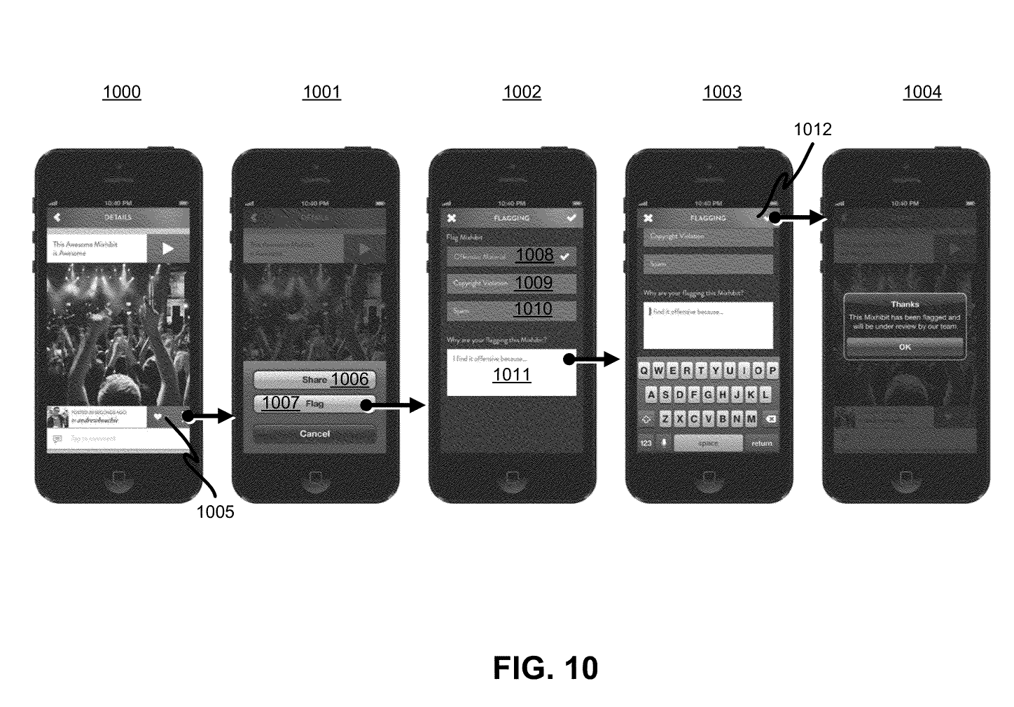

Reference will now be made to the interfaces 1000 through 1004 shown in FIG. 10. The interface 1000 includes an action icon 1005 adjacent to a thumbnail of a corresponding social media compilation. The user may select the action icon 1005 to cause the interface 1001 to be presented, including buttons 1006 and 1007 that enable one or more actions to be performed in connection with the corresponding social media compilation.

The user may select the flag button 1007 to cause the interface 1002 to be presented, enabling the user to flag the social media compilation for one or more reasons. For example, the interface 1002 includes three check boxes, 1008, 1009, and 1010, that enable the user to flag the compilation to indicate that the compilation (1) includes offensive material, (2) violates a copyright, and/or (3) is a so-called spam message, respectively. The interface 1002 also includes a text box 1011, which, when selected by the user, causes interface 1003 to be presented, enabling the user to input comments explaining the reason(s) that the user is flagging the social media compilation. If the user selects a check icon 1012 shown in the interface 1003, then the interface 1004 is presented, indicating that the social media compilation has been flagged. In one example, when a social media compilation is flagged, it is forwarded for review by a team of reviewers for possible deletion.

### Deleting a Social Media Compilation

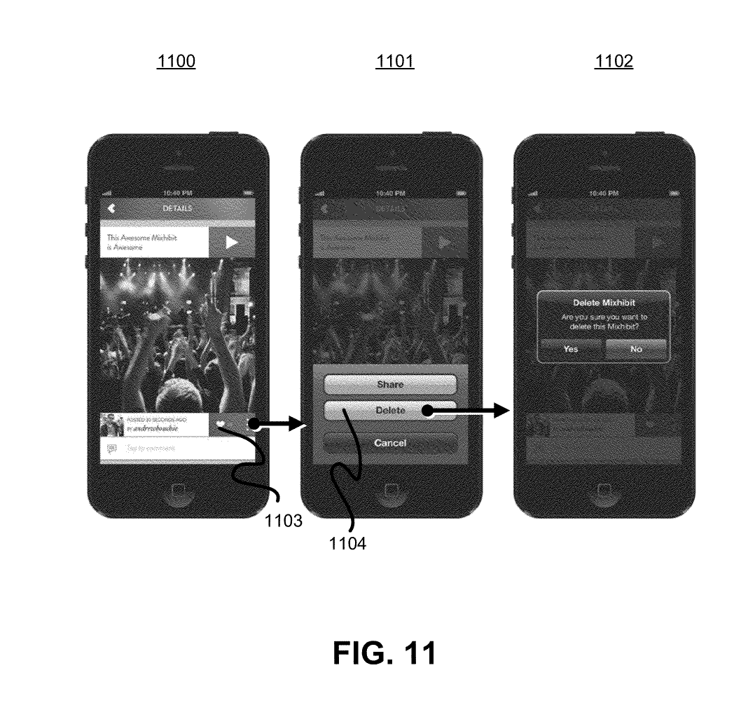

Referring now to the interfaces 1100 through 1102 shown in FIG. 11, the user may select the action icon 1103 adjacent to a thumbnail of a corresponding social media compilation, to cause the interface 1101 to be presented, including buttons (e.g., a delete button 1104) that enable one or more actions to be performed in connection with the corresponding social media compilation. The user may select the delete button 1104 shown in the interface 1101 to cause the interface 1102 to be presented, enabling the user to delete the social media compilation that corresponds to the action icon 1103.

### Sharing a Social Media Compilation

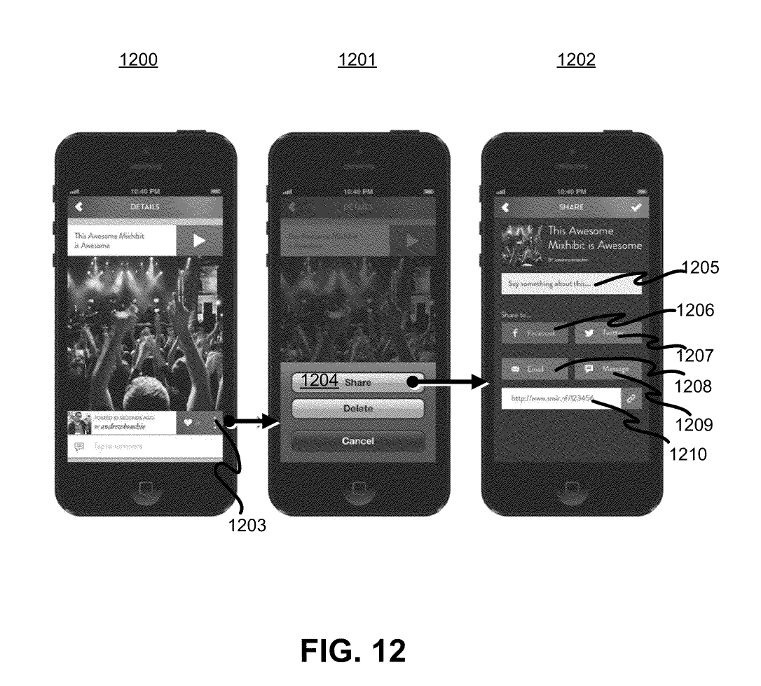

Reference will now be made to the interfaces 1200 through 1202 shown in FIG. 12. The user may select an action icon 1203 adjacent to a thumbnail of a corresponding social media compilation, to cause the interface 1201 to be presented, including buttons (e.g., a share button 1204) that enable one or more actions to be performed in connection with the corresponding social media compilation. The user may select the share button 1204 to cause the interface 1202 to be presented, enabling the user to share the corresponding social media compilation with one or more other users. The interface 1202 includes a text box 1205 in which the user may input a comment to be associated with the social media compilation to be shared. The interface 1202 also includes buttons 1206 through 1209, individual ones of which enable the user to share the social media compilation with other users via email, text message, or one or more social media applications hosted by social media service provider(s) (e.g., Facebook®, Twitter®, Instagram®, Foursquare®, etc.). Also provided via the interface 1202 is a hyperlink 1210 to the social media compilation, which the user may send to other users to share the social media compilation.

### Social Media Compilation Categories

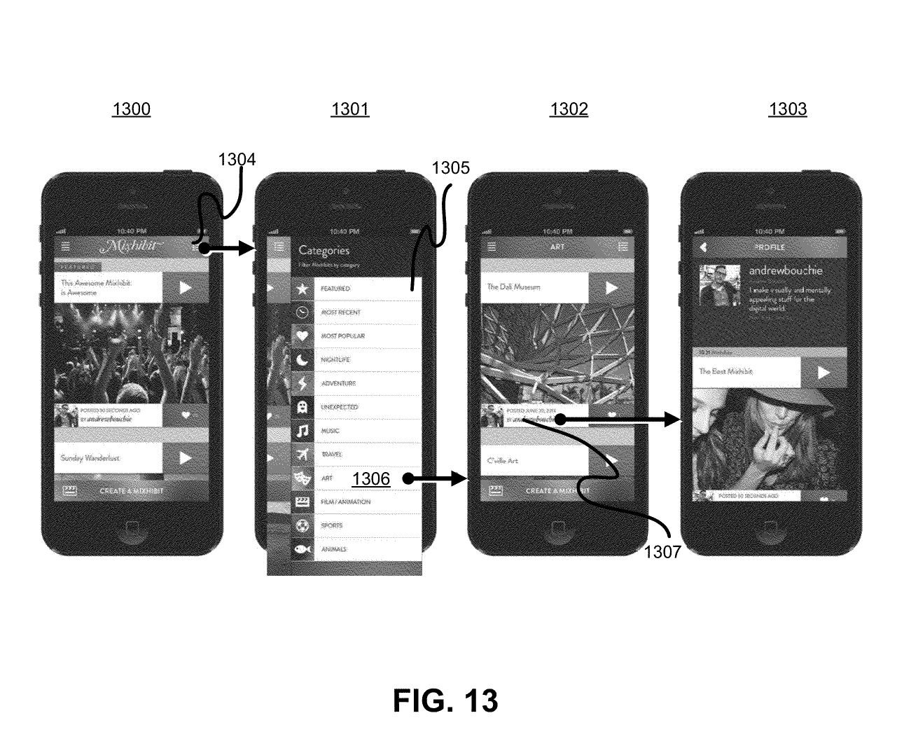

Referring now to the interfaces 1300 through 1303 shown in FIG. 13, if the user selects a category icon 1304, then the interface 1301 is presented to provide a listing 1305 of categories, enabling the user to view social media compilations that have been categorized in a particular category, such as, for example, music, travel, art, sports, animals, etc. For example, if the user selects an art category icon 1306, then the interface 1302 is presented, including a listing of social media compilations that have been categorized in the art category. In the interface 1302, the user may select a user identifier 1307 (e.g., a user name) corresponding to a user who created a particular social media compilation, thereby causing the interface 1303 to be presented, showing a public personal profile of the user corresponding to the user identifier 1307.

### Friends and their Profiles

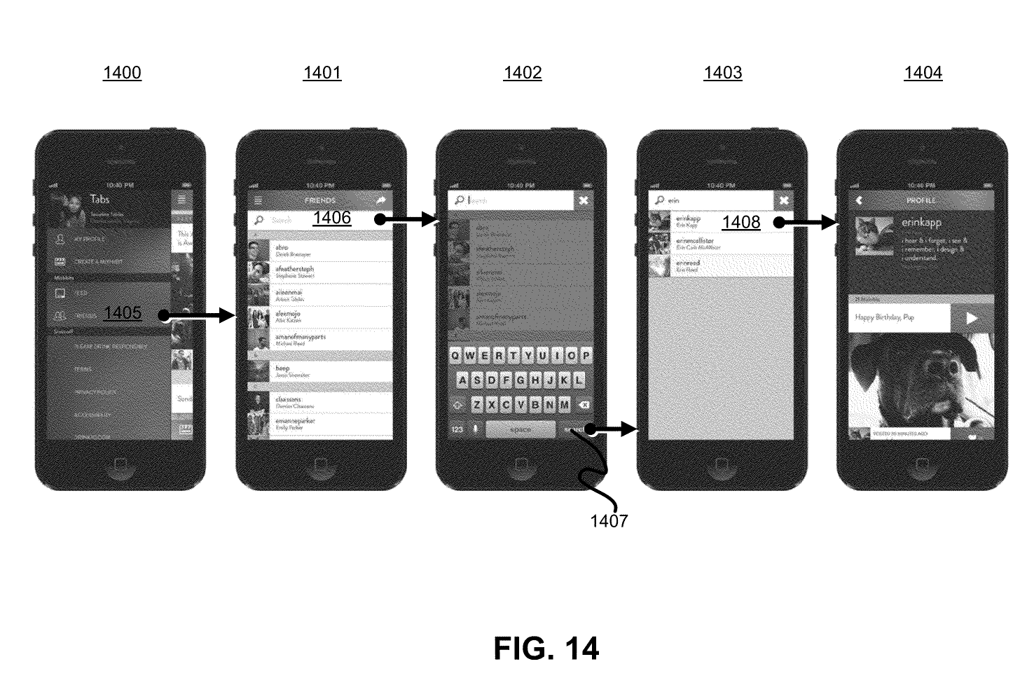

Reference will now be made to the interfaces 1400 through 1404 shown in FIG. 14. The interface 1400 includes a listing of menu items that includes a menu item 1405 for viewing a listing of friends having one or more social media accounts associated with a social media account of the user. The user may select the menu item 1405 to cause the interface 1401 to be presented, showing a listing of friends of the user. The interface 1401 also includes a search text box 1406, which, when selected by the user, causes the interface 1402 to be presented, enabling the user to search the listing of friends. If the user inputs a text string into the text box 1406 and then selects a search button 1407, then the interface 1403 is presented showing search results identified based on the text string. If, in the interface 1403, the user selects the search result 1408 corresponding to a particular user, then the interface 1404 is presented, showing a personal profile of that particular user.

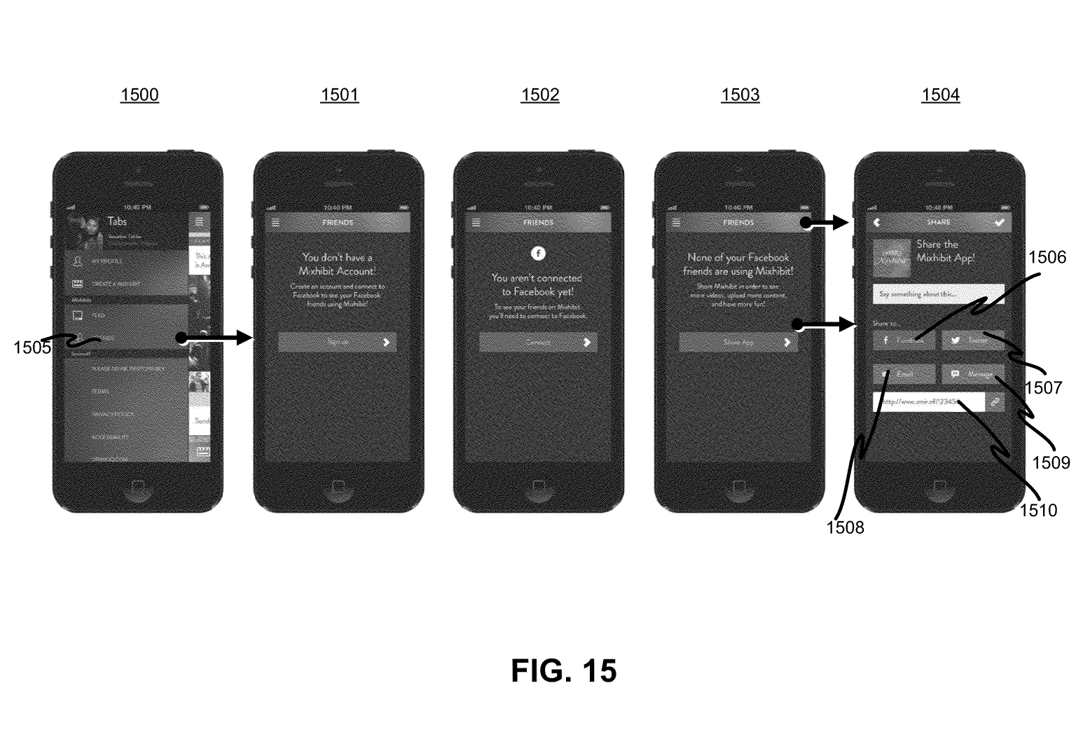

Referring now to the interfaces 1500 through 1504 shown in FIG. 15 (and in a similar manner as that described above in connection with the interface 1400), the interface 1500 includes a listing of menu items that includes a menu item 1505 for viewing a listing of friends having one or more social media accounts associated with a social media account of the user. If the user selects the menu item 1505 and the user has not yet established a user account for the mobile application, then the interface 1501 is presented, indicating that the user has not established a user account, and inviting the user to establish a user account.

If the user selects the menu item 1505 and the user has not yet connected the user account for the application to a social media service provider (e.g., Facebook®, Twitter®, Instagram®, Foursquare®, etc.) to the application, then the interface 1502 is presented, indicating that the user has not connected the user account to a social media service provider, and inviting the user to connect the user account to a social media service provider.

If the user selects the menu item 1505 and none of the user's friends (e.g., which have social media account(s) linked to one or more social media accounts of the user) has established a user account for the application, then the interface 1503 is presented, indicating that such is the case, and inviting the user to send a message to one or more of the friends asking them to establish their own user accounts for the application. The interface 1504 includes buttons 1506 through 1509 that enable the user to send the message to other users via email, text message, or a social media application hosted by a social media service provider (e.g., Facebook®, Twitter®, Instagram®, Foursquare®, etc.). Also provided via the interface 1504 is a hyperlink 1510 to a page enabling the other users to establish an account for the application.

### Creating a Social Media Compilation

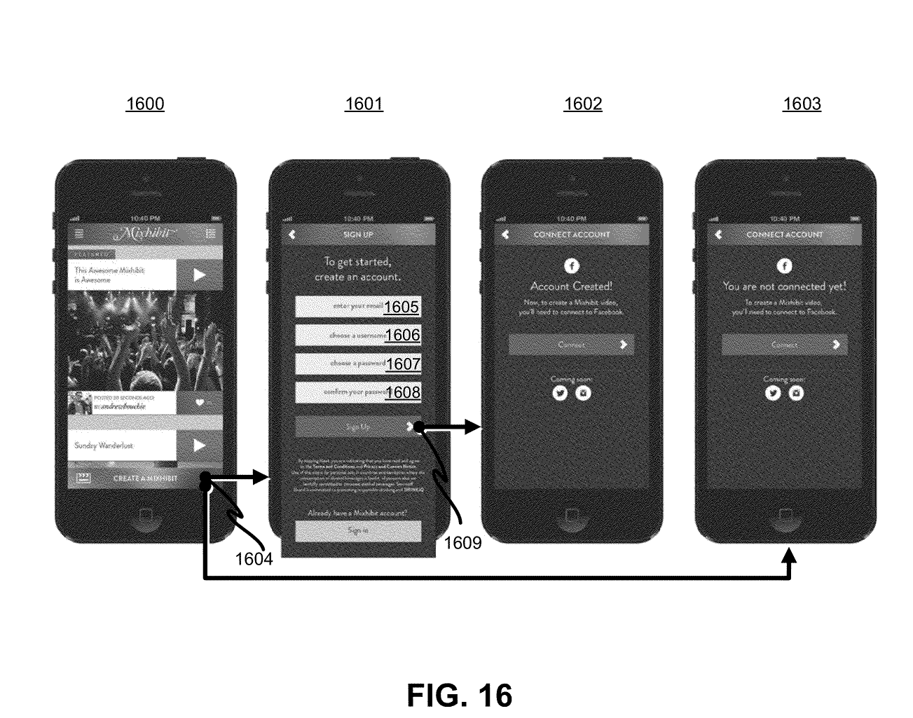

Reference will now be made to the interfaces 1600 through 1603 shown in FIG. 16. If the user selects a button 1604 for creating a social media compilation and the user has not yet established a user account for the application, then the interface 1601 is presented, indicating that such is the case, and inviting the user to establish a user account for the application. The interface 1601 includes text boxes 1605 through 1608 in which the user may enter information (e.g., an email address, a username, a password, etc.) to be associated with a new user account. If, after entering information into the text boxes 1605 through 1608, the user selects a sign up button 1609, then the new user account is created and the interface 1602 is presented to confirm that the new user account has been created.

If the user selects the button 1604 for creating a social media compilation, and the user has not yet connected the user account to a social media service provider (e.g., Facebook®, Twitter®, Instagram®, Foursquare®, etc.), then the interface 1603 is presented, indicating that the user has not yet connected the user account to a social media service provider, and inviting the user to connect the user account to a social media service provider.

### Creation Options & Date Selection

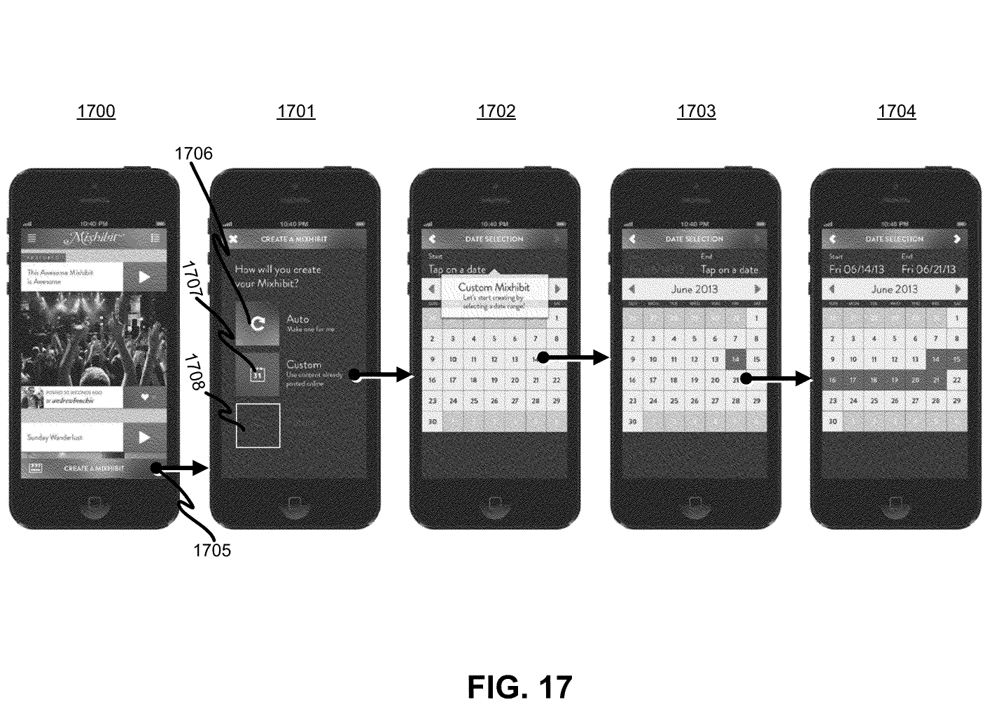

Referring now to the interfaces 1700 through 1704 shown in FIG. 17, the user may select a button 1705 for creating a social media compilation, to cause the interface 1701 to be presented. The interface 1701 includes an automatic button 1706, a custom button 1707, and a record button 1708, which correspond to three different options, respectively, for creating a social media compilation.

Although not shown in FIG. 17 for purposes of convenience, if the user selects the automatic button 1706, then the application automatically (e.g., requiring only minimal additional user input, or requiring no additional user input) generates a social media compilation based on items of social media content that have been created in association with one or more social media accounts (e.g., held by the user and/or by additional account holders linked to the user's account) connected to the user account for the application.

Although not shown in FIG. 17 for purposes of convenience, if the user selects the record button 1708, then the application designates the time and/or date that the record button 1708 was pressed as the start time and/or date for a social media compilation. If the user selects a stop recording button (not shown in FIG. 17), then the application designates the time and/or date that the stop record button was pressed as the end time and/or date for the social media compilation. In this case, items of social media content that are created between the start time and/or date and the stop time and/or date, will be included in the social media compilation.

If the user selects the custom button 1707, then the interface 1702 is presented, including an interactive calendar that the user may interact with to create a date range for the social media compilation. In general (e.g., unless specifically excluded by the user in a step described below), items of social media content that were created on a day within the date range will be included in the social media compilation. The user may tap on a date (e.g., Jun. 14, 2013, in the example of interface 1702) to select a start date for the social media compilation. The user may then tap on another date (e.g., Jun. 21, 2013, in the example of interface 1703) to select an end date for the social media compilation. In one example, the days that fall within the date range (e.g., Jun. 14, 2013, through Jun. 21, 2013, in the example of the interface 1704) are shaded in the calendar to indicate the entered date range.

### Adding, Removing, and Rearranging Items of Social Media Content

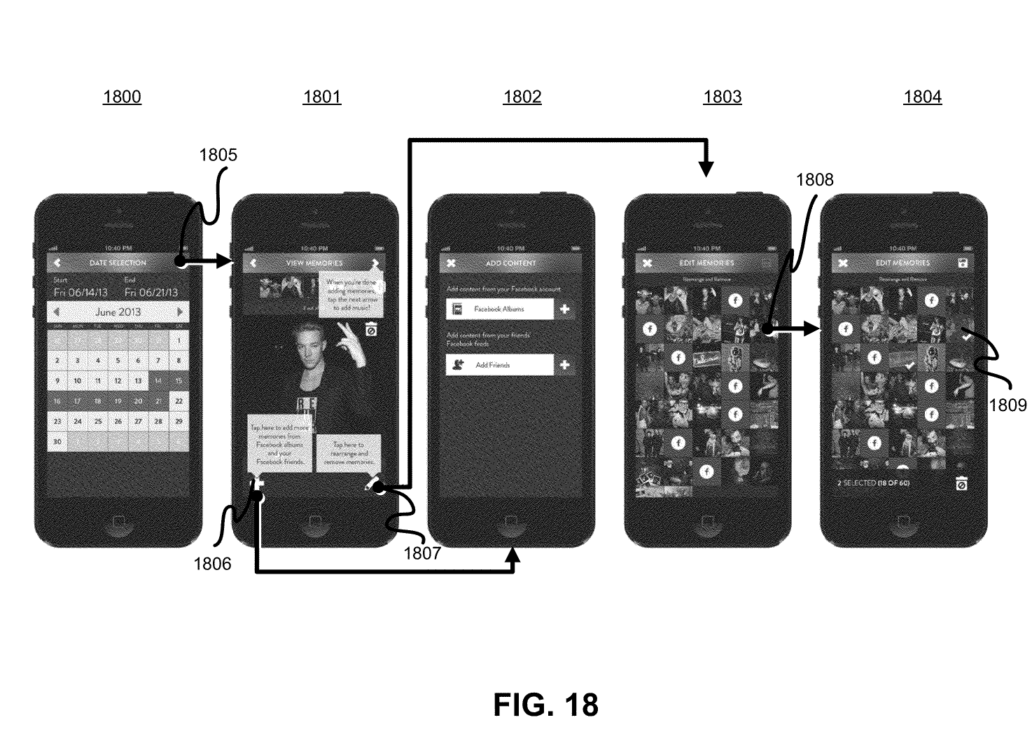

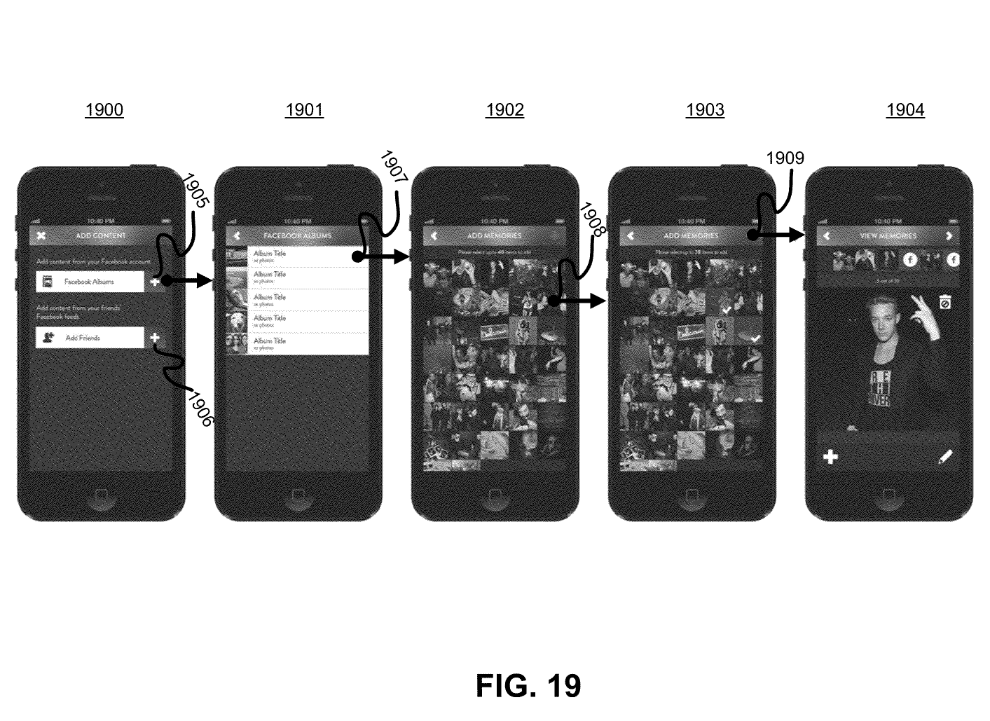

Reference will now be made to the interfaces 1800 through 1804 shown in FIG. 18. After inputting a date range (as described above in connection with FIG. 17), the user may select a next button 1805 in the interface 1800, to cause items of social media content that were created on a date within the designated date range to be aggregated from the previously configured one or more social media accounts of the one or more users/account holders, and to cause the interface 1801 to be presented. The interface 1801 shows the items of social media content (also sometimes referred to herein as memories) that have been aggregated from the connected social media accounts (e.g., the user's account and/or accounts of other account holders linked to the user's account) and that were created (e.g., uploaded) on a date/time that falls within the designated date/time range. As will be described in further detail below in the context of FIG. 19, the interface 1801 may include an add button 1806 that the user may select to begin to add additional items of social media content to the social media compilation being generated.

The interface 1801 also includes an edit button 1807 that the user may select to begin to edit the social media compilation. In particular, the user may select the edit button 1807 to cause the interface 1803 to be presented. The interface 1803 includes a two-dimensional array of items (e.g., thumbnails) of social media content, each of which is selectable by the user to cause the corresponding item of social media content to be included in the social media compilation. In one example, the two-dimensional array may include one or more thumbnail images corresponding to one or more photographic items of social media content (e.g., a photograph that was previously uploaded to a social media account). In another example, the two-dimensional array may include one or more logos corresponding to one or more social media service providers (e.g., Facebook® logo, a Twitter® logo, an Instagram® logo, a Foursquare® logo, and/or another type of logo). Each logo may correspond to a textual item of social media content (e.g., a status update, a tweets, and/or the like) that was posted to a social media account hosted by the corresponding social media service provider. Each textual item of social media content that is selected for inclusion in the social media compilation may be overlaid upon one or more other items of social media content (e.g., photographic items of social media content) in the social media compilation. In FIG. 18, only the logo for one social media service provider is shown, but it should be understood that more than one logo may be shown when there is textual content from more than one social media service provider. The user can, in one example, select an element 1808 of the array corresponding to a particular item of social media content, thereby causing a check mark 1809 to be overlaid upon that element 1808 of the array, indicating that the corresponding item of social media content will be included in the social media compilation. In another example, the user may select and drag any item (e.g., thumbnail) corresponding to an item of social media content shown in the array to rearrange the order in which the items of social media content will be presented in the social media compilation.

### Adding Social Media Content from Albums

Referring now to the interfaces 1900 through 1904 shown in FIG. 19, the interface 1900 includes a button 1905, for adding to the social media compilation items of social media content from a social media account (e.g., a Facebook® account) of the user, and a button 1906, for adding to the social media compilation items of social media content from a social media account of another account holder. The user may select the button 1905 for adding items of social media content from the social media account of the user, to cause the interface 1901 to be presented. The interface 1901 includes a listing of collections (sometimes referred to as albums) of social media content from the social media account of the user. The user may select a listing 1907 of a collection of social media content to cause the interface 1902 to be presented. The interface 1902 includes a two-dimensional array of items of social media content belonging to the selected listing 1907 of social media content. Each entry of the array is selectable by the user to cause the corresponding item of social media content to be included in the social media compilation. For example, the user may select an element 1908 of the array corresponding to an item of social media content, to cause a check mark to be overlaid upon that element 1908 of the array, indicating that the corresponding item of social media content will be included in the social media compilation. The user may select a next button 1909, to cause the interface 1904 to be presented, enabling the user to view the items of social media content that have been selected thus far for inclusion in the social media compilation, by swiping left and/or right through a listing of such items of social media content.

### Adding/Removing Social Media Content from Accounts of Friends

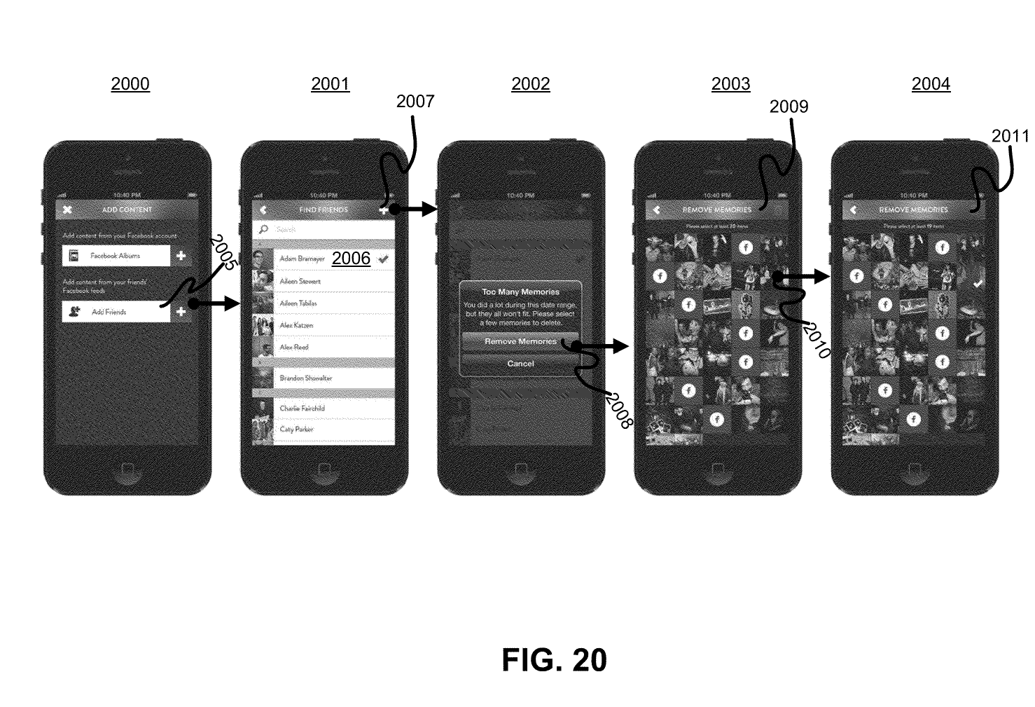

Reference will now be made to the interfaces 2000 through 2004 shown in FIG. 20. The interface 2000 includes a button 2005 for adding to the social media compilation items of social media content from a social media account (e.g., a Facebook® account) of another account holder. The user may select the button 2005 to cause the interface 2001 to be presented. The interface 2001 includes a listing of other holders of one or more social media accounts (sometimes referred to as friends or other account holders). Each element of the listing of other account holders is selectable by the user to cause the application to link the social media account(s) of the corresponding other account holder to the social media account of the user, thereby enabling items of social media content of the other account holder to be included in the social media compilation.

After the user selects one of the elements 2006 of the listing of other account holders, the user may select a next button 2007 to cause the application to aggregate items of social media content from that other account holder (e.g., items of social media content that were created on a date/time within the date/time range, if any, that was previously designated for the compilation).

In one example, if the number of items of social media content aggregated from that other account holder causes the size of the social media compilation to exceed a predefined threshold, then the interface 2002 is presented to the user. The interface 2002 includes a button 2008 that the user may select to cause the interface 2003 to be presented, thereby enabling the user to begin to remove items of social media content from the social media compilation, to decrease its size so as not to exceed the predefined threshold.

The interface 2003 indicates an amount 2009 of items of social media content that must be removed from the social media compilation in order for its size not to exceed the predefined threshold. The interface 2003 also includes a two-dimensional array of items of social media content to be included in, or removed from, the social media compilation. Each entry of the array is selectable by the user to cause the corresponding item of social media content to be removed from the social media compilation. For example, the user may select an element 2010 of the array corresponding to an item of social media content, to cause a check mark to be overlaid upon that element 2008 of the array, indicating that the corresponding item of social media content will be removed from the social media compilation. Once the amount of items of social media content selected to be removed is greater than or equal to the minimally required amount 2009, the user may select a remove button 2011 to remove the selected items of social media content from the social media compilation.

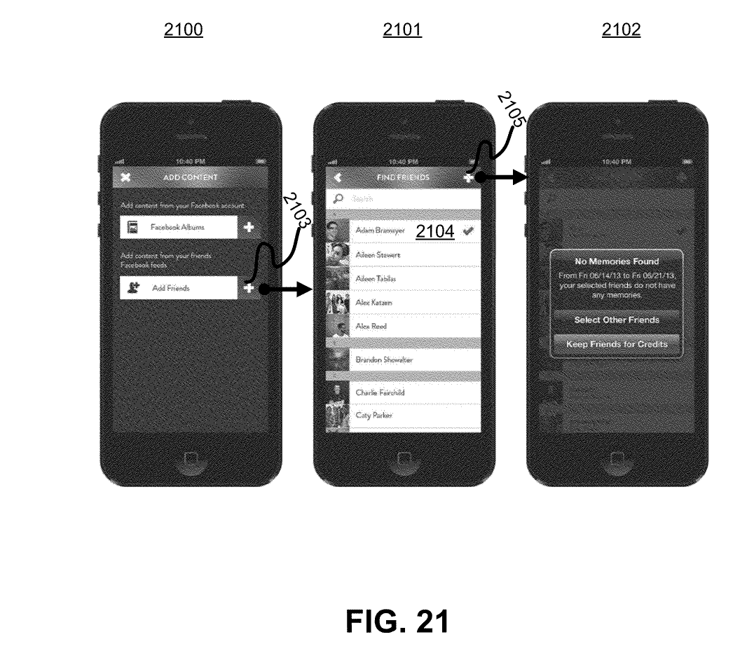

Referring now to the interfaces 2100 through 2102 shown in FIG. 21, the interface 2100 includes a button 2103 for adding to the social media compilation items of social media content from a social media account (e.g., a Facebook® account) of another account holder (e.g., an account holder other than the user). The user may select the button 2103 to cause the interface 2101 to be presented. The interface 2101 includes a listing of other holders of one or more social media accounts (sometimes referred to as friends or other account holders). After the user selects a button 2104 corresponding to another account holder, the user may select a next button 2105 to cause the application to aggregate items of social media content, if any, from that other account holder (e.g., items of social media content that were created on a date/time within the date/time range, if any, that was previously designated for the compilation). In one example, if no such items of social media content from that other account holder are found during the aggregating, then the interface 2102 is presented to the user, indicating that no items of social media content were found that satisfy the criteria provided by the user during the configuration of the social media compilation (e.g., the designation of a date/time range as described above in the context of FIG. 17).

### Adding Music and Details to Social Media Compilation

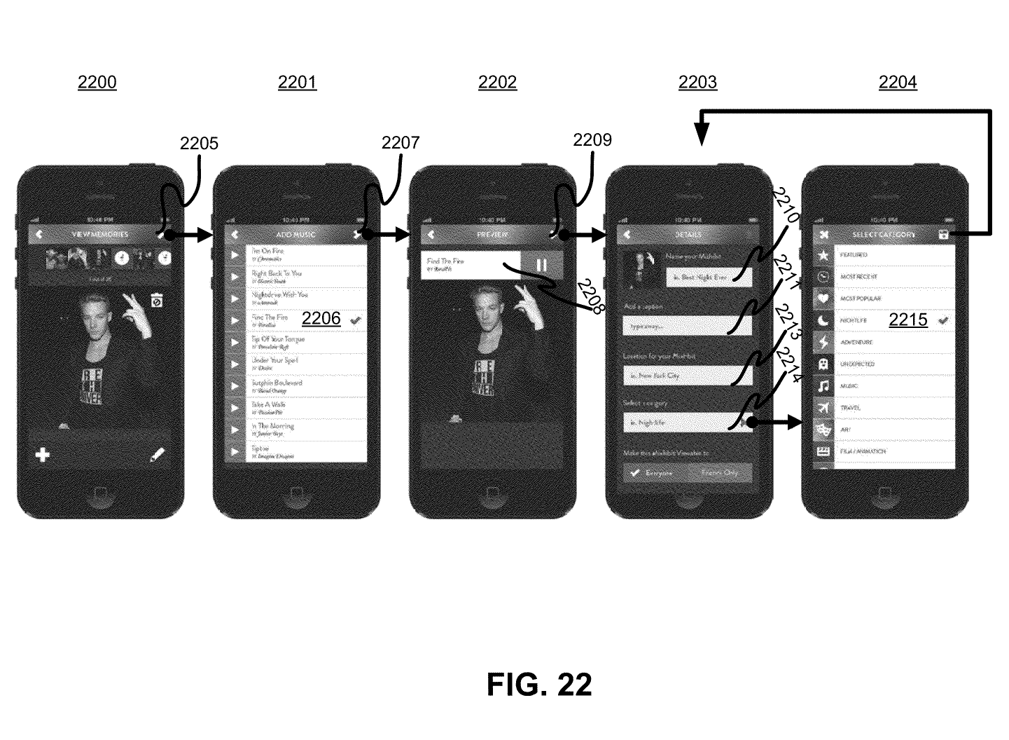

Reference will now be made to the interfaces 2200 through 2204 shown in FIG. 22. The user may select a next button 2205 to cause the interface 2201 to be presented. The interface 2201 includes a listing of songs (also referred to herein as soundtracks) from which the user may select a song to be incorporated into the social media compilation. The user selects a song (e.g., song 2206) and then selects a next button 2207, thereby causing the interface 2202 to be presented. The interface 2202 includes a play/pause toggle button 2208 that the user may select to cause the application to play a preview of the social media compilation concurrently with the selected song 2206. In one example, the social media compilation is formatted as a slideshow of items of social media content aggregated from the social media account(s) of the user and/or of one or more additional account holder(s). The items of social media content may be arranged in a sequence arranged and/or approved by the user, as described above in the context of FIG. 18, and/or may include textual items of social media content (e.g., status updates, tweets, and/or the like) overlaid upon photographic items of social media content.

The user may select a next button 2209 to cause the interface 2203 to be presented, enabling the user to input details for the social media compilation. For example, the interface 2203 includes fields 2210 through 2214, in certain ones of which the user may input a name; a caption; a location (e.g., a town or other location related to the items of social media content); and a category (e.g., featured, most recent, most popular, nightlife, adventure, unexpected, music, travel, art, film/animation, etc.), for the social media compilation.

In one example, the user may select the category field 2214 to cause the interface 2204 to be presented. The interface 2204 includes a listing of categories that the user may select to associate with the social media compilation. The user may select a category (e.g., the nightlife category 2215) from the listing, and then select a save button 2216, to cause the interface 2203 to be presented, indicating that the selected category 2215 has been assigned to the social media compilation.

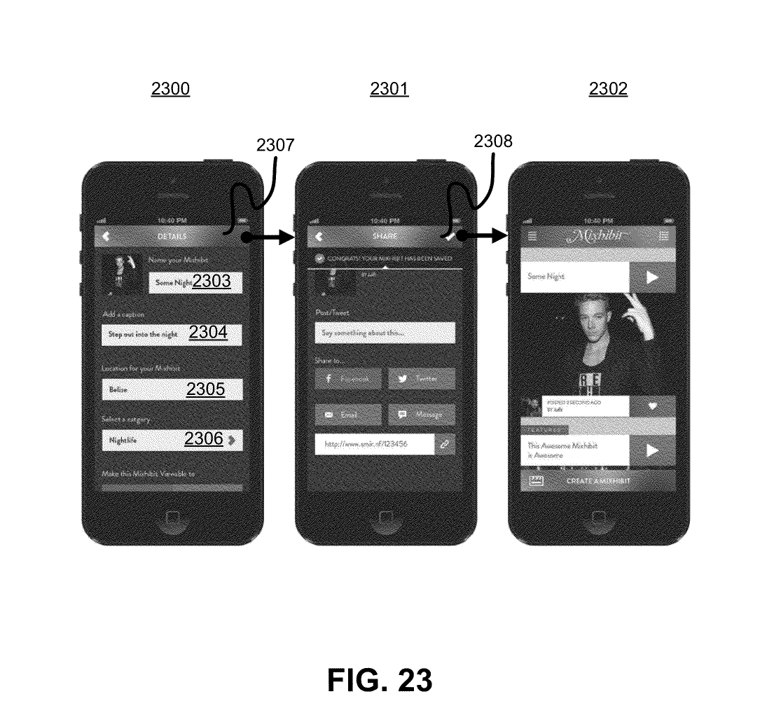

Referring now to the interfaces 2300 through 2302 shown in FIG. 23, after the user inputs details for the social media compilation into fields 2303 through 2306, the user may select a next button 2307 in the interface 2300, to cause the interface 2301 to be presented. The interface 2301 indicates that the social media compilation has been saved, and enables the user to share the social media compilation with one or more other users via email, text message, a social media application hosted by a social media service provider, and/or a hyperlink, as described above in the context of FIG. 12. The user may select a next button 2308 to cause the interface 2302 to be presented, indicating that the social media compilation has been added to the user's social media compilation feed (described above in the context of FIG. 8).

### Editing Personal Profile

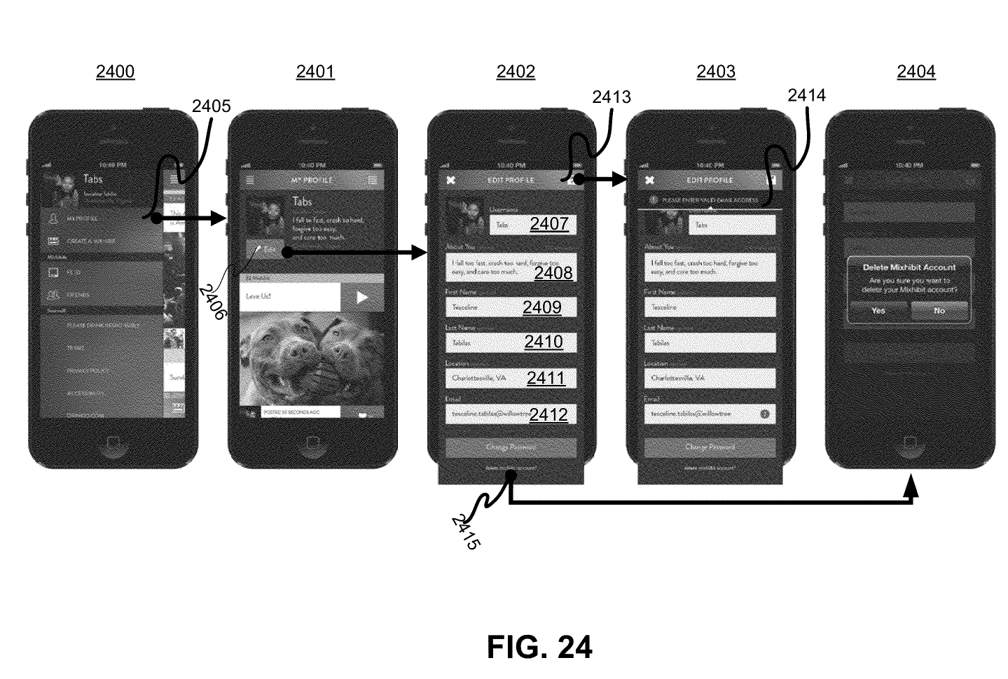

Reference will now be made to the interfaces 2400 through 2404 shown in FIG. 24. The interface 2400 includes a list of menu items that the user may select, for example, to view the user's personal profile, create a social media compilation, view feeds, view friend information, log out of the application, and/or the like. The user may select the profile button 2405 to cause the interface 2401 to be presented, showing the personal profile of the user. The interface 2401 includes an edit button 2406 that, when selected by the user, causes the interface 2402 to be presented. The interface 2402 includes input fields 2407 through 2412 that enable the user to input personal profile information, such as a user name, information about the user, a first name of the user, a last name of the user, a location (e.g., residential town) of the user, and an email address of the user. After inputting personal profile information into the input fields 2407 through 2412, the user may select a save button 2413, thereby causing the inputted personal profile information to be saved in the user's personal profile. If the application identifies any error(s) in the personal profile information (e.g., an invalid email address), then the user is notified, for example, by way of a notification message, such as the message 2414 shown in the interface 2403. The interface 2402 also includes a delete button 2415 that, when selected, causes the interface 2404 to be presented, enabling the user to delete their user account.

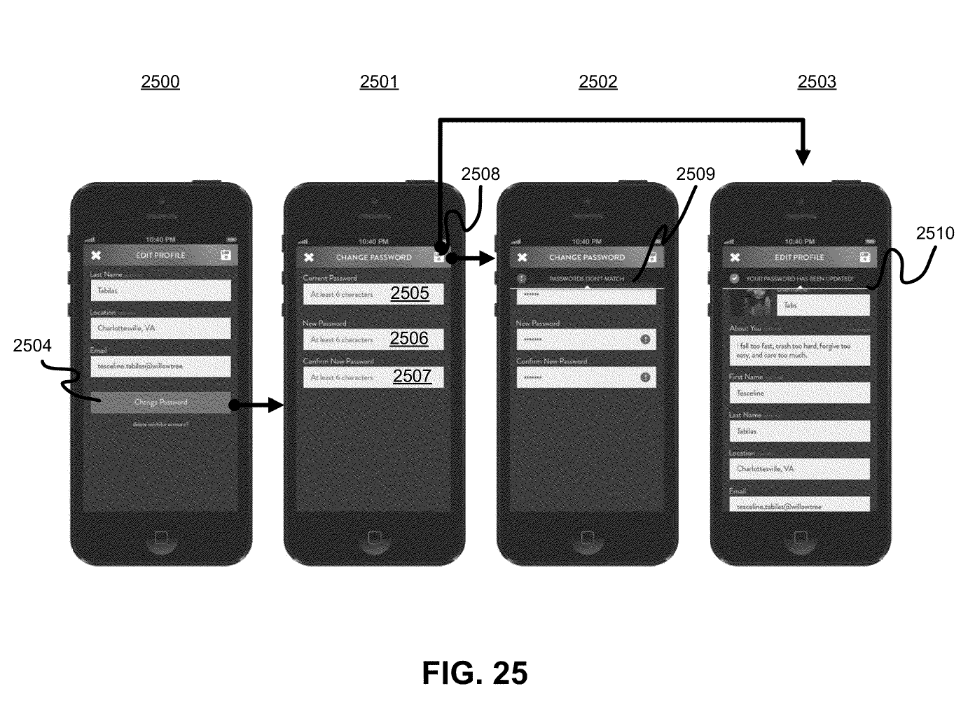

Referring now to the interfaces 2500 through 2503 shown in FIG. 25, the user may select a change password button 2504, to cause the interface 2501 to be presented, enabling the user to change his or her password for accessing the application. After entering password information into fields 2505 through 2507, the user selects a save button 2508. If the entered password information is incorrect (e.g., the passwords entered in fields 2506 and 2507 do not match), then the interface 2502 is presented including an error message 2509 and enabling the user to correct the error. If the entered password information is correct, then the interface 2503 is presented including a message 2510 confirming that the password change has been successful.

### Messages and Logging Out

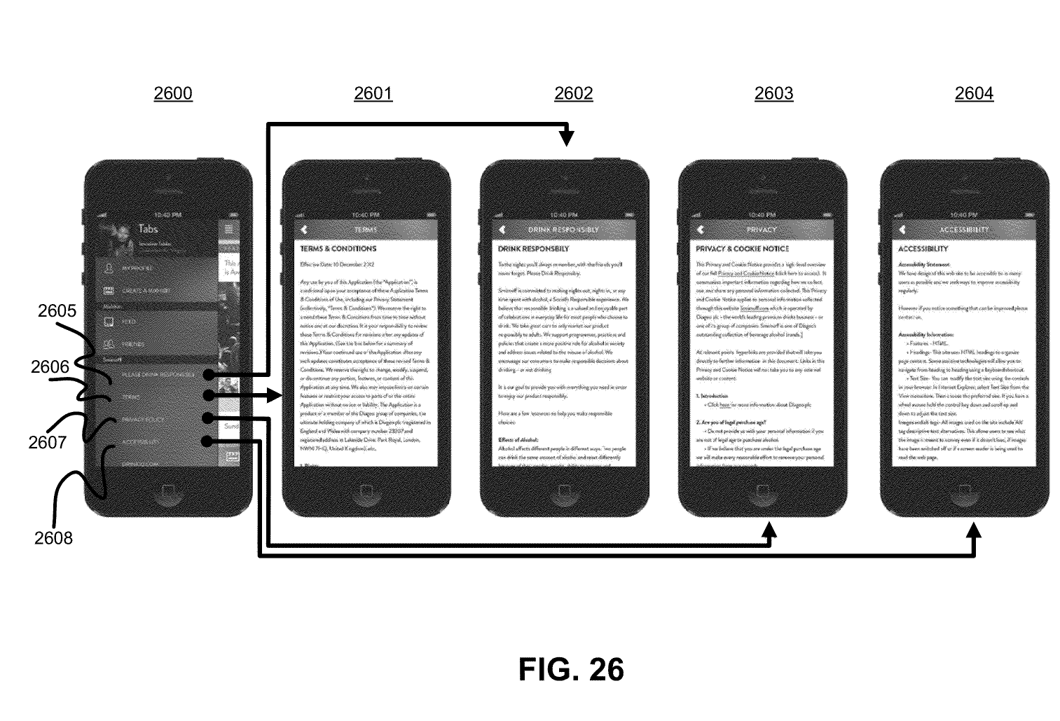

Reference will now be made to the interfaces 2600 through 2604 shown in FIG. 26. The interface 2600 includes a list of menu items 2605 through 2608 which may be selected to present various types of messages. For instance, selecting the menu item 2605 causes a “drink responsibly” message to be presented by way of the interface 2606. Selecting the menu item 2606 causes a “terms and conditions” message to be presented by way of the interface 2601. Selecting the menu item 2607 causes a “privacy policy” message to be presented by way of the interface 2603. Selecting the menu item 2608 causes an “accessibility” message to be presented by way of the interface 2604.

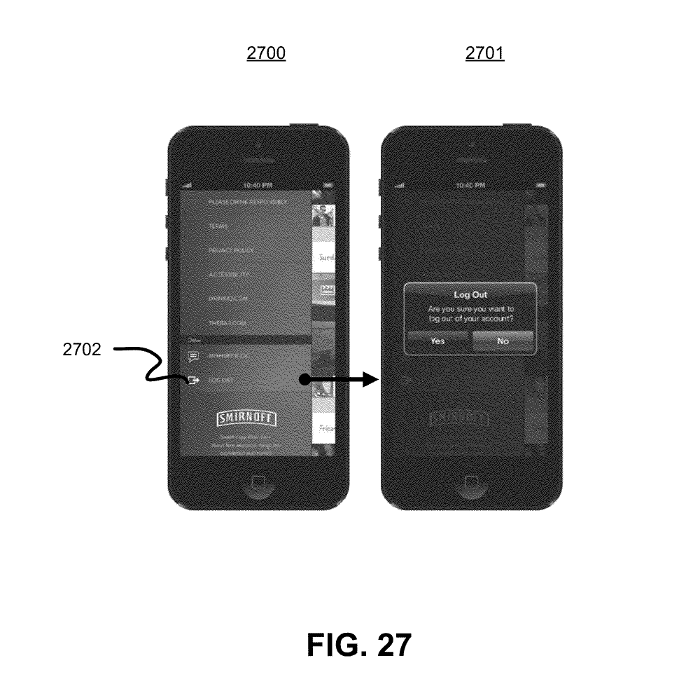

Referring now to the interfaces 2700 and 2701 shown in FIG. 27, the user may select a log out button 2702 shown in the interface 2700 to cause the interface 2701 to be presented, enabling the user to log out of the mobile application.

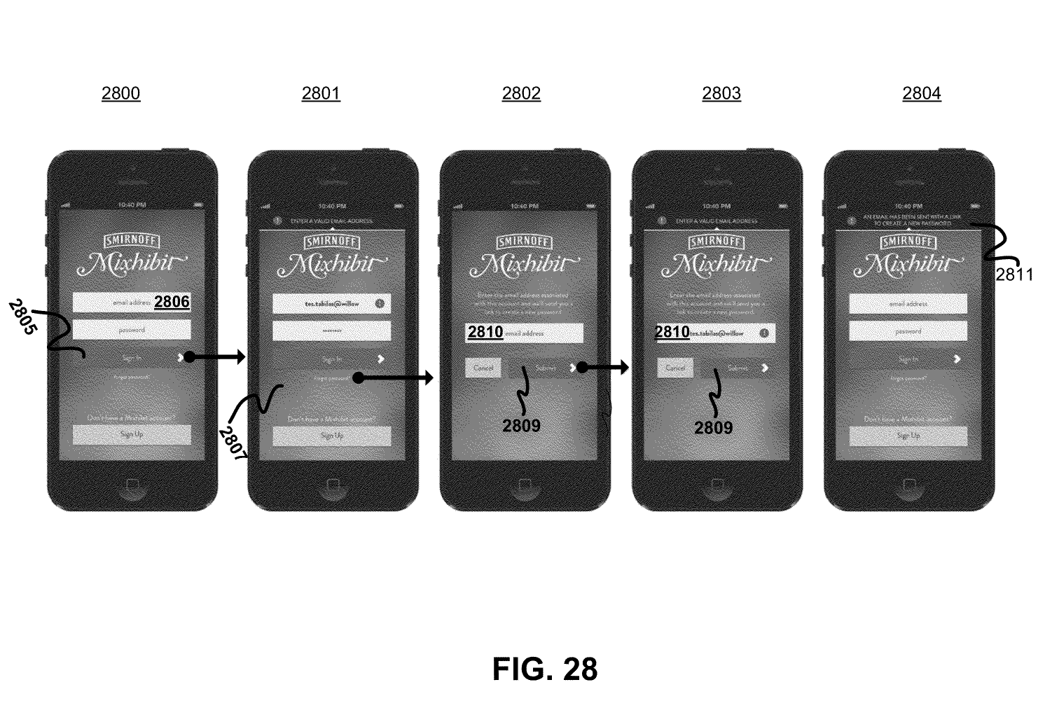

Reference will now be made to interfaces 2800 through 2804 shown in FIG. 28. If the user selects a sign in button 2805 without having entered a valid email address into field 2806, then the interface 2801 is presented including a message 2808 requesting the user to enter a valid email address into the field 2806. The user may select a forgot password button 2807 to cause the interface 2802 to be presented. If the user selects a submit button 2809 shown in the interface 2802 without having entered a valid email address into field 2810, then the interface 2803 is presented including a message requesting the user to enter a valid email address into field 2810. The user may select the submit button 2809 after inputting a valid email address into the field 2810 to cause the interface 2804 to be presented, including a message 2811 confirming that a link to create a new password has been sent to the entered email address of the user.

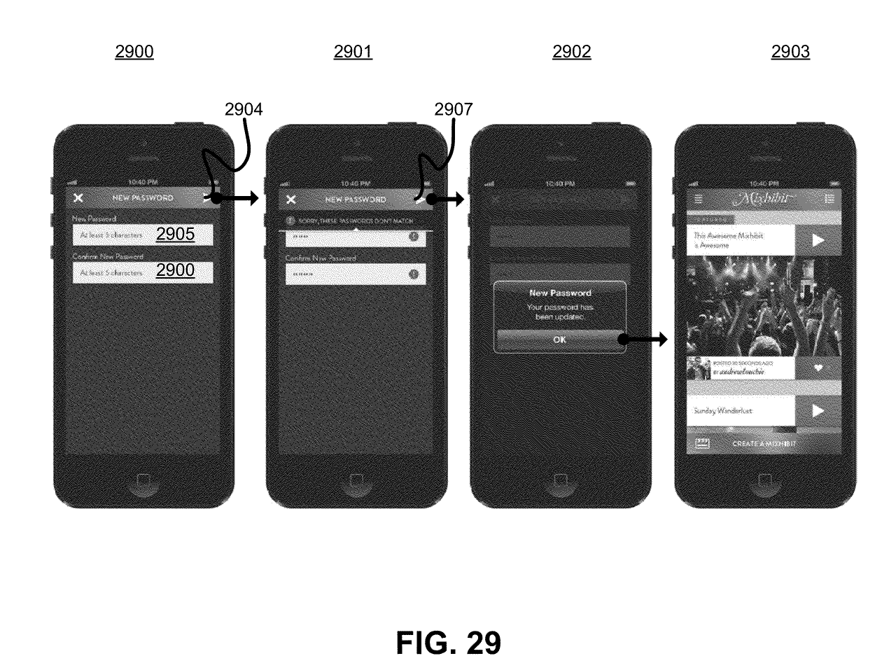

Referring now to the interfaces 2900 through 2903 shown in FIG. 29, the user may be presented with the interface 2900 for creating a new password for the user's account for the application. If the user selects a button 2904 without having entered matching passwords in fields 2905 and 2906, then the interface 2901 is presented, including a message 2907 indicating that the entered passwords do not match. If the user enters valid matching passwords into the fields 2905 and 2906 and then selects a next button 2907, then the interface 2902 is presented confirming that the password has been successfully saved. Selecting an ok button causes the interface 2903 to be presented, showing the social media compilation feed (described above in further detail).

As can be appreciated in view of the above, the example embodiments described herein provide systems, methods, and computer program products for providing a custom video and/or audio compilation of social media content that is aggregated from numerous social media accounts and/or platforms, and enabling the compilation to be easily shared and enjoyed by many users.

While various example embodiments have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for providing a social media compilation, the system comprising:
a computer processor; and
a memory device accessible by the computer processor and storing at least one of:
computer code executable by the computer processor, and
data used by the computer code,
wherein the computer code includes:
an input module that receives compilation configuration information inputted by a first account holder, the compilation configuration information including information identifying social media accounts of the first account holder,
a content aggregation module that aggregates items of social media content of the social media accounts of the first account holder based on the compilation configuration information, and
a compilation generation module that generates a social media compilation based on the compilation configuration information and the items of social media content.

2. The system of claim 1, wherein the items of social media content used by the compilation generation module are not stored in the memory device or in another storage medium associated with the social media compilation.

3. The system of claim 1,
wherein the compilation configuration information inputted by the first account holder includes sequence information for ordering the items of social media content, and
wherein the content aggregation module aggregates the items of social media content in a desired sequence according to the sequence information.

4. The system according to claim 1,
wherein the compilation configuration information includes audio information of a soundtrack to be associated with the social media compilation, and
wherein the compilation generation module outputs the social media compilation in conjunction with the soundtrack.

5. The system of claim 1, wherein the social media accounts include any one or a combination of:
a Facebook® account;
a Twitter® account;
an Instagram® account; and
a Foursquare® account.

6. The system of claim 1, wherein the compilation configuration information further includes a temporal range for the items of social media content to be aggregated by the content aggregation module for the social media compilation.

7. The system of claim 1,
wherein the compilation configuration information further includes information identifying a social media account of a second account holder, and
wherein the content aggregation module aggregates items of social media content of the second account holder in addition to aggregating the items of social media content of the first account holder.

8. The system of claim 1, wherein the compilation configuration information further includes any one or a combination of:
a compilation identifier, which identifies a name associated with the social media compilation,
a location identifier, which identifies a geographical location associated with the social media compilation,
a date identifier, which identifies a date associated with the social media compilation,
an event identifier, which identifies an event associated with the social media compilation, and
a category identifier, which identifies a category, from a plurality of predefined categories, to which the social media compilation belongs.

9. The system of claim 1, wherein the content aggregation module aggregates the items of social media content by using one or more application programming interfaces of one or more social media service providers.

10. The system of claim 1, wherein the information identifying the social media accounts of the first account holder includes credentials usable to log into the social media accounts of the first account holder.

11. The system of claim 1,
wherein the computer code further includes a display module that produces an array of data, the array including a first dimension with entries corresponding to one or more account holders and a second dimension with entries corresponding to one or more social media accounts of the one or more account holders, and
wherein each entry of the array is selectable by the first account holder to cause items of social media content of the one or more social media accounts of the one or more account holders to be aggregated for the social media compilation or to be excluded from the social media compilation.

12. The system of claim 1, wherein the items of social media content include:
photographic social media entries,
graphical social media entries,
videographic social media entries, and
textual social media entries.

13. The system of claim 12,
wherein the compilation generation module generates the social media compilation by:
adding the textual social media entries as overlays to one or more of the photographic social media entries, or one or more of the graphical social media entries, or both, to produce merged entries, and
arranging the merged entries in a sequence that includes one or more other photographic social media entries, or one or more other graphical social media entries, or both, and
wherein the compilation generation module outputs the sequence concurrently with an audio soundtrack.

14. The system of claim 1, wherein the compilation generation module arranges the items of social media content in chronological order.

15. The system of claim 1, wherein the computer code further includes an editing module that enables the first account holder to edit the social media compilation generated by the compilation generation module.

16. The system of claim 15, wherein the editing module enables the first account holder to arrange the items of social media content in the social media compilation to be in a customized order sequence.

17. The system of claim 15, wherein the editing module enables the first account holder to select one or more of the items of social media content to be included in the social media compilation or to be excluded from the social media compilation.

18. The system of claim 15, wherein the editing module enables the first account holder to select, from a plurality of predefined audio soundtracks, an audio soundtrack to be output together with the social media compilation.

19. The system of claim 15, wherein the editing module enables the first account holder to upload an audio soundtrack to be output together with the social media compilation.

20. The system of claim 1, wherein the computer code further includes a preview module that enables the first account holder to preview the social media compilation.

21. The system of claim 1, wherein the memory device stores at least one of:
the information identifying the social media accounts of the first account holder,
credentials usable to log into the social media accounts of the first account holder,
information identifying the social media accounts of at least one account holder other than the first account holder, and
the compilation configuration information.

22. The system of claim 1, wherein the computer code further includes a sharing module that outputs the social media compilation to a display device when the social media compilation is requested via a hyperlink.

23. The system of claim 1,
wherein the social media compilation is not stored on a computer-readable storage medium, and
wherein, each time a hyperlink associated with the social media compilation is selected, the content aggregation module aggregates anew the items of social media content according to the compilation configuration information, and the compilation generation module generates anew the social media compilation.

24. A method for providing a social media compilation, the method comprising steps of:
receiving compilation configuration information inputted by a first account holder, the compilation configuration information including information identifying social media accounts of the first account holder;
aggregating items of social media content of the social media accounts of the first account holder based on the compilation configuration information; and
generating a social media compilation based on the compilation configuration information and the items of social media content.

25. The method of claim 24,
wherein the items of social media content used in the generating step are not stored in a memory device associated with the social media compilation, and
wherein, each time a hyperlink associated with the social media compilation is selected, the items of social media content are aggregated anew according to the compilation configuration information, and the social media compilation is generated anew.

26. The method of claim 24,
wherein the compilation configuration information inputted by the first account holder includes sequence information for ordering the items of social media content, and
wherein the method further includes a step of aggregating the items of social media content in a desired sequence according to the sequence information.

27. The method according to claim 24,
wherein the compilation configuration information includes audio information of a soundtrack to be associated with the social media compilation, and
wherein the method further includes a step of outputting the social media compilation in conjunction with the soundtrack.

28. The method of claim 24, wherein the social media accounts include any one or a combination of:
a Facebook® account;
a Twitter® account;
an Instagram® account; and
a Foursquare® account.

29. The method of claim 24, wherein the compilation configuration information further includes a temporal range for the items of social media content to be aggregated for the social media compilation.

30. The method of claim 24,
wherein the compilation configuration information further includes information identifying a social media account of a second account holder, and
wherein the method further includes a step of aggregating items of social media content of the second account holder in addition to aggregating the items of social media content of the first account holder.

31. The method of claim 24, wherein the compilation configuration information further includes any one or a combination of:
a compilation identifier, which identifies a name associated with the social media compilation,
a location identifier, which identifies a geographical location associated with the social media compilation,
a date identifier, which identifies a date associated with the social media compilation,
an event identifier, which identifies an event associated with the social media compilation, and
a category identifier, which identifies a category, from a plurality of predefined categories, to which the social media compilation belongs.

32. The method of claim 24, wherein the aggregating the items of social media content includes using one or more application programming interfaces of one or more social media service providers.

33. The method of claim 24, wherein the information identifying the social media accounts of the first account holder includes credentials usable to log into the social media accounts of the first account holder.

34. The method of claim 24, further including a step of producing an array of data, the array including a first dimension with entries corresponding to one or more account holders and a second dimension with entries corresponding to one or more social media accounts of the one or more account holders,
wherein each entry of the array is selectable by the first account holder to cause items of social media content of the one or more social media accounts of the one or more account holders to be aggregated for the social media compilation or to be excluded from the social media compilation.

35. The method of claim 24, wherein the items of social media content include:
photographic social media entries,
graphical social media entries,
videographic social media entries, and
textual social media entries.

36. The method of claim 35,
wherein the generating the social media compilation includes:
adding the textual social media entries as overlays to one or more of the photographic social media entries, or one or more of the graphical social media entries, or both, to produce merged entries, and
arranging the merged entries in a sequence that includes one or more other photographic social media entries, or one or more other graphical social media entries, or both, and
wherein the method further includes a step of outputting the sequence concurrently with an audio soundtrack.

37. The method of claim 24, further including a step of arranging the items of social media content in chronological order.

38. The method of claim 24, further including a step of editing the generated social media compilation.

39. The method of claim 38, further including a step of arranging the items of social media content in the social media compilation to be in a customized order sequence.

40. The method of claim 38, further including a step of receiving a selection of one or more of the items of social media content to be included in the social media compilation or to be excluded from the social media compilation.

41. The method of claim 38, further including a step of receiving a selection of one of a plurality of predefined audio soundtracks audio soundtracks to be output together with the social media compilation.

42. The method of claim 38, further including a step of uploading an audio soundtrack to be output together with the social media compilation.

43. The method of claim 24, further including a step of previewing the social media compilation.

44. The method of claim 24, further including a step of storing at least one of:
the information identifying the social media accounts of the first account holder,
credentials usable to log into the social media accounts of the first account holder,
information identifying the social media accounts of at least one account holder other than the first account holder, and
the compilation configuration information.

45. The method of claim 24, further including a step of outputting the social media compilation to a display device when the social media compilation is requested via a hyperlink.

46. The method of claim 24,
wherein the social media compilation is not stored on a computer-readable storage medium, and
wherein, the method further includes steps of, each time a hyperlink associated with the social media compilation is selected:
aggregating anew the items of social media content according to the compilation configuration information, and
generating anew the social media compilation.

47. A non-transitory computer-readable medium having stored a computer program that, when executed by a computer processor, causes the computer processor to perform a method for providing a social media compilation,
wherein the method comprises steps of:
receiving compilation configuration information inputted by a first account holder, the compilation configuration information including information identifying social media accounts of the first account holder;
aggregating items of social media content of the social media accounts of the first account holder based on the compilation configuration information; and
generating a social media compilation based on the compilation configuration information and the items of social media content.

48. The non-transitory computer-readable medium of claim 47,
wherein the items of social media content used in the generating step are not stored in a memory device associated with the social media compilation, and
wherein the method further includes, each time a hyperlink associated with the social media compilation is selected:
aggregating anew the items of social media content according to the compilation configuration information, and
generating anew the social media compilation.

49. The non-transitory computer-readable medium of claim 47,
wherein the compilation configuration information inputted by the first account holder includes sequence information for ordering the items of social media content, and
wherein the method further includes aggregating the items of social media content in a desired sequence according to the sequence information.

50. The non-transitory computer-readable medium according to claim 47,
wherein the compilation configuration information includes audio information of a soundtrack to be associated with the social media compilation, and
wherein the method further includes outputting the social media compilation in conjunction with the soundtrack.

51. The non-transitory computer-readable medium of claim 47, wherein the social media accounts include any one or a combination of:
a Facebook® account;
a Twitter® account;
an Instagram® account; and
a Foursquare® account.

52. The non-transitory computer-readable medium of claim 47, wherein the compilation configuration information further includes a temporal range for the items of social media content to be aggregated for the social media compilation.

53. The non-transitory computer-readable medium of claim 47,
wherein the compilation configuration information further includes information identifying a social media account of a second account holder, and
wherein the method further includes aggregating items of social media content of the second account holder in addition to aggregating the items of social media content of the first account holder.

54. The non-transitory computer-readable medium of claim 47, wherein the compilation configuration information further includes any one or a combination of:
a compilation identifier, which identifies a name associated with the social media compilation,
a location identifier, which identifies a geographical location associated with the social media compilation,
a date identifier, which identifies a date associated with the social media compilation,
an event identifier, which identifies an event associated with the social media compilation, and
a category identifier, which identifies a category, from a plurality of predefined categories, to which the social media compilation belongs.

55. The non-transitory computer-readable medium of claim 47, wherein the aggregating the items of social media content includes using one or more application programming interfaces of one or more social media service providers.

56. The non-transitory computer-readable medium of claim 47, wherein the information identifying the social media accounts of the first account holder includes credentials usable to log into the social media accounts of the first account holder.

57. The non-transitory computer-readable medium of claim 47,
wherein the method further includes producing an array of data, the array including a first dimension with entries corresponding to one or more account holders and a second dimension with entries corresponding to one or more social media accounts of the one or more account holders, and
wherein each entry of the array is selectable by the first account holder to cause items of social media content of the one or more social media accounts of the one or more account holders to be aggregated for the social media compilation or to be excluded from the social media compilation.

58. The non-transitory computer-readable medium of claim 47, wherein the items of social media content include:
photographic social media entries,
graphical social media entries,
videographic social media entries, and
textual social media entries.

59. The non-transitory computer-readable medium of claim 58,
wherein the generating the social media compilation includes:
adding the textual social media entries as overlays to one or more of the photographic social media entries, or one or more of the graphical social media entries, or both, to produce merged entries, and
arranging the merged entries in a sequence that includes one or more other photographic social media entries, or one or more other graphical social media entries, or both, and
wherein the method further includes a step of outputting the sequence concurrently with an audio soundtrack.

60. The non-transitory computer-readable medium of claim 47, wherein the method further includes a step of arranging the items of social media content in chronological order.

61. The non-transitory computer-readable medium of claim 47, wherein the method further includes a step of editing the generated social media compilation.

62. The non-transitory computer-readable medium of claim 61, wherein the method further includes a step of arranging the items of social media content in the social media compilation to be in a customized order sequence.

63. The non-transitory computer-readable medium of claim 61, wherein the method further includes a step of receiving a selection of one or more of the items of social media content to be included in the social media compilation or to be excluded from the social media compilation.

64. The non-transitory computer-readable medium of claim 61, wherein the method further includes a step of receiving a selection of one of a plurality of predefined audio soundtracks that is to be output together with the social media compilation.

65. The non-transitory computer-readable medium of claim 61, wherein the method further includes a step of uploading an audio soundtrack to be output together with the social media compilation.

66. The non-transitory computer-readable medium of claim 47, wherein the method further includes a step of previewing the social media compilation.

67. The non-transitory computer-readable medium of claim 47, wherein the method further includes a step of storing at least one of:
the information identifying the social media accounts of the first account holder,
credentials usable to log into the social media accounts of the first account holder,
information identifying the social media accounts of at least one account holder other than the first account holder, and
the compilation configuration information.

68. The non-transitory computer-readable medium of claim 47, wherein the computer code further includes a sharing module that outputs the social media compilation to a display device when the social media compilation is requested via a hyperlink.

69. The non-transitory computer-readable medium of claim 47,
wherein the social media compilation is not stored on the computer-readable medium, and
wherein the method further includes, each time a hyperlink associated with the social media compilation is selected:
aggregating anew the items of social media content according to the compilation configuration information, and
generating anew the social media compilation.

70. The system of claim 1,
wherein the compilation configuration information inputted by the first account holder includes geographical information, and
wherein, based on the geographical information, the content aggregation module aggregates the items of social media content that are determined, based on the geographical information, to be associated with a geographical region.

71. The method of claim 24,
wherein the compilation configuration information inputted by the first account holder includes geographical information, and
wherein the method further includes a step of aggregating the items of social media content that are determined, based on the geographical information, to be associated with a geographical region.

72. The non-transitory computer-readable medium of claim 47,
wherein the compilation configuration information inputted by the first account holder includes geographical information, and
wherein the method further includes aggregating the items of social media content that are determined, based on the geographical information, to be associated with a geographical region.
